(19) United States
(12) Patent Application Publication
(10) Pub. No.: US 2019/0208785 A1
(43) Pub. Date: Jul. 11, 2019

(54) Composition and Methods for Reducing Nematodes

(71) Applicant: Monsanto Technology LLC, St. Louis, MO (US)

(72) Inventors: Kent A. Croon, Chesterfield, MO (US); Donald W. Edgecomb, Chesterfield, MO (US); Ken L. Ferreira, Wentzville, MO (US); Michael S. South, Chesterfield, MO (US)

(73) Assignee: Monsanto Technology LLC, St. Louis, MO (US)

(21) Appl. No.: 16/063,115

(22) PCT Filed: Dec. 16, 2016
(86) PCT No.: PCT/US2016/067278

§ 371 Date: Jun. 15, 2018

Related U.S. Application Data
(60) Provisional application No. 62/269,673, filed on Dec. 18, 2015.

(51) Int. Cl. A01N 43/88; A01N 63/00; C12R 1/465

(52) U.S. Cl. CPC A01N 43/88; C12R 1/465; A01N 63/00

(57) ABSTRACT

Plant parasitic nematode can infect crops and causes significant economic losses in agriculture. We developed methods and compositions comprising (a) an inoculant comprising Streptomyces lydicus, and (b) a chemical component comprising a 3,5-disubstituted-1,2,4-oxadiazole or a salt thereof, to reduce an effect of a plant parasitic nematode population on a plant or seed in soil.

### CROSS-REFERENCE TO RELATED APPLICATION

This application is a U.S. National Stage Application of International Application No. PCT/US2016/067278, filed Dec. 16, 2016, which claims priority to U.S. Provisional Patent Application No. 62/269,673, filed Dec. 18, 2015, each of which are hereby incorporated by reference in their entireties.

### FIELD

The present specification provides composition and methods for reducing nematodes.

### BACKGROUND

Nematodes (derived from the Greek word for thread) are active, flexible, elongate, organisms that live on moist surfaces or in liquid environments, including films of water within soil and moist tissues within other organisms. While only 20,000 species of nematode have been identified, it is estimated that 40,000 to 10 million actually exist. Many species of nematodes have evolved to be very successful parasites of plants and are responsible for significant economic losses in agriculture (Whitehead (1998) Plant Nematode Control. CAB International, New York).

Plant parasitic nematodes can infect all parts of plants, including roots, developing flower buds, leaves, and stems. They are classified on the basis of their feeding habits into the broad categories migratory ectoparasites, migratory endoparasites, and sedentary endoparasites. Sedentary endoparasites, which included the root knot nematodes (Meloidogyne) and cyst nematodes (Globodera and Heterodera) induce feeding sites and establish long-term infections within roots that are often very damaging to crops (Whitehead, supra). It is estimated that parasitic nematodes cost the horticulture and agriculture industries in excess of $78 billion worldwide a year, based on an estimated average 12% annual loss spread across all major crops. For example, it is estimated that nematodes cause soybean losses of approximately $3.2 billion annually worldwide (Barker et al. (1994) Plant and Soil Nematodes: Societal Impact and Focus for the Future. The Committee on National Needs and Priorities in Nematology. Cooperative State Research Service, U.S. Department of Agriculture and Society of Nematologists). Current yield loss estimates due to nematode damage are about 2% in corn and about 5% in soybean. Several factors make the need for safe and effective nematode controls urgent.

Nematode management strategies include resistant germplasm, various cultural practices and seed treatments. In the specialty markets, economic hardship resulting from nematode infestation is particularly high in strawberries, bananas, and other high value vegetables and fruits. In crop markets, where crops suffer from significant nematode infestation including potato, pepper, onion, citrus, coffee, sugarcane, greenhouse ornamentals and golf course turf grasses.

Accordingly, there remains a need in the art to develop compositions that combine the use of chemical and biological means of plant parasitic nematode control in large-scale, commercial agricultural applications, particularly in seed treatment applications, to protect against nematode infestations. The present specification describes compositions and methods as effective ways to solve this problem.

### SUMMARY

The present specification includes compositions and methods for reducing an effect of a plant parasitic nematode population in a plant, soil, or seed. The present specification further provides that treatment with a composition comprising: (a) an inoculant comprising Streptomyces lydicus, and (b) a chemical component comprising a 3,5-disubstituted-1,2,4-oxadiazole or a salt thereof, results in reduction of an effect of the population of plant parasitic nematode.

The compositions and methods disclosed herein can be used in combination with other crop management systems.

The present specification also provides a method of reducing an effect of a plant parasitic nematode population on a plant or seed in soil comprising applying to the plant, soil, or seed a composition comprising: (a) an inoculant comprising Streptomyces lydicus, and (b) a chemical component comprising a 3,5-disubstituted-1,2,4-oxadiazole or a salt thereof.

The present specification further provides a method comprising providing to a person a first container of seeds and a composition comprising: (a) an inoculant comprising Streptomyces lydicus, and (b) a chemical component comprising a 3,5-disubstituted-1,2,4-oxadiazole or a salt thereof, where the composition is capable of reducing a first population of plant parasitic nematode for a first population of plants germinating from the first container of seeds relative to a second population of plant parasitic nematode for a second population of plants grown in a comparable field from a second container of seeds where the composition was not provided.

In a further aspect, the present specification includes a method of reducing a first plant parasitic nematode population for a first plant, soil, or a seed comprising growing the first plant from the first seed in the first soil with a composition comprising: (a) an inoculant comprising Streptomyces lydicus, and (b) a chemical component comprising a 3,5-disubstituted-1,2,4-oxadiazole or a salt thereof, where the composition is capable of reducing the first plant parasitic nematode population for the first plant, soil, or seed relative to a second plant, soil, or seed in need of reducing a second plant parasitic nematode population without the composition.

The present specification further provides a method comprising growing a first population of plants from a first container of seeds, where the seeds are planted in soil with a composition comprising an inoculant comprising Streptomyces lydicus and a chemical component comprising a 3,5-disubstituted-1,2,4-oxadiazole or a salt thereof, where the composition is capable of increasing a yield of the first population of plants relative to a second population of plants, soil, or a second container of seeds grown in a comparable field without the composition.

In another aspect, the present specification includes a method comprising: (a) treating a first container of seeds with a composition comprising an inoculant comprising Streptomyces lydicus and a chemical component comprising a 3,5-disubstituted-1,2,4-oxadiazole or a salt thereof, and (b) providing the treated first container of seeds to a farmer for growing in a field, where the composition is capable of reducing a first plant parasitic nematode population for a first population of plants germinating from the first container of seeds relative to a second plant parasitic nematode population for a second population of plants in a comparable field germinating from a second container of seeds where the composition was not applied.

In yet another aspect, the present specification further includes a method of reducing a first plant parasitic nematode population for a first plant, soil, or a seed comprising: (a) planting the first seed in the first soil; (b) applying a composition comprising an inoculant comprising Streptomyces lydicus and a chemical component comprising a 3,5-disubstituted-1,2,4-oxadiazole or a salt thereof to the first plant germinating from the first seed or to the first soil, where the composition is capable of reducing the first population of plant parasitic nematode in the first plant, soil, or seed relative to a second plant, soil, or seed in need of reducing a second plant parasitic nematode population where the composition was not applied.

Yet another aspect of the present specification includes a method of protecting against nematode infection for a first plant, soil, or a seed, the method comprising: (a) providing a composition comprising an inoculant comprising Streptomyces lydicus and a chemical component comprising a 3,5-disubstituted-1,2,4-oxadiazole or a salt thereof, and (b) applying the composition to the first plant, soil, or seed where the composition is capable of protecting the first plant against plant parasitic nematode infection relative to a second plant, soil, or seed in need of protecting against nematode infection where the composition was not applied.

In a further aspect, the present specification includes a method for reducing the susceptibility to nematode infections or enhancing the germination frequency for a first seed, the method comprises: (a) immersing the first seed in a composition comprising an inoculant comprising Streptomyces lydicus and a chemical component comprising a 3,5-disubstituted-1,2,4-oxadiazole or a salt thereof, and (b) planting the first seed in a field, where the composition is capable of reducing the susceptibility to nematode infections or enhancing the germination frequency of the first seed relative to a second seed in need of reducing the susceptibility to nematode infections or enhancing the germination frequency where the composition was not immersed.

The present specification further provides a method of reducing an effect of a first plant parasitic nematode population on a first plant and a seed in soil comprising applying to the first plant, soil, or seed a composition comprising an inoculant comprising Streptomyces lydicus, where the composition is capable of reducing the effect of the first population of plant parasitic nematode relative to a second plant parasitic nematode population where the composition was not applied to a second plant, soil, or seed.

In another aspect, the present specification includes a plant parasitic nematicidal composition comprising: (a) an inoculant comprising Streptomyces lydicus, and (b) a chemical component comprising a 3,5-disubstituted-1,2,4-oxadiazole or a salt thereof, where the composition is capable of reducing an effect of a first plant parasitic nematode population on a first plant or seed in soil relative to a second plant or seed in soil in need of reducing the effect of a second plant parasitic nematode population where the composition was not applied.

In a further aspect, the present specification includes a method comprising applying to a first corn plant, soil, or corn seed a composition comprising (a) a first inoculant comprising Streptomyces lydicus, and (b) a chemical component comprising a 3,5-disubstituted-1,2,4-oxadiazole or a salt thereof, where the composition is capable of reducing an effect of the first population of plant parasitic nematode for the first corn plant or corn seed in soil relative to a second corn plant or corn seed in soil in need of reducing the effect of a second corn plant parasitic nematode population where the composition was not applied and (c) a second inoculant comprising Penicillium bilaii to the first corn plant, soil, or corn seed, where the first corn plant, soil, or corn seed is grown in a field in which corn was grown during a growing season that immediately precedes planting of the population of corn plants or corn seeds, where the inoculant is capable of reducing a corn-on-corn yield penalty.

In another aspect, the present specification includes a method comprising applying to a first corn plant, soil, or corn seed a composition comprising (a) a first inoculant comprising Streptomyces lydicus, where the composition is capable of reducing an effect of the first population of plant parasitic nematode for the first corn plant or corn seed in soil relative to a second corn plant or corn seed in soil in need of reducing the effect of a second corn plant parasitic nematode population where the composition was not applied and (b) a second inoculant comprising Penicillium bilaii to the first corn plant, soil, or corn seed, where the first corn plant, soil, or corn seed is grown in a field in which corn was grown during a growing season that immediately precedes planting of the population of corn plants or corn seeds, where the inoculant is capable of reducing a corn-on-corn yield penalty.

### DESCRIPTION OF DRAWINGS

FIG. 1: Comparison of Tioxazafen, ACTINOVATE®, and Tioxazafen plus ACTINOVATE® in reduction of root knot nematode (Meloidogyne incognita) in corn plants.

FIG. 2: Comparison of Tioxazafen, ACTINOVATE®, and Tioxazafen plus ACTINOVATE® in reduction of soybean cyst nematode (Heterodera glycines) in soybean plants.

FIG. 3: Reduction of root knot nematode in tomato plants using ACTINOVATE®.

### DETAILED DESCRIPTION

Unless defined otherwise, technical and scientific terms as used herein have the same meaning as commonly understood by one of ordinary skill in the art. One skilled in the art will recognize many methods can be used in the practice of the present specification. Indeed, the present specification is in no way limited to the methods and materials described. Any references cited herein are incorporated by reference in their entireties. Singular forms “a,” “an,” and “the” are intended to include the plural forms as well, unless the context indicates otherwise.

Streptomyces lydicus

The present specification sets forth a composition comprising an inoculant comprising Streptomyces lydicus, for treating a plant, soil, or seed. Such compositions are useful to reduce an effect of a population of plant parasitic nematode, reduce the susceptibility of plants to nematode infection, or enhance the growth of treated plants. Where not limited by any particular scientific theory, Streptomyces lydicus is shown to exhibit strong antagonism towards a wide range of nematodes, including corn root knot and soybean cyst nematodes. In one aspect, Streptomyces lydicus produces metabolites that are destructive to the nematode egg, thereby reducing their population in the soil and root zone of plants. As such, Streptomyces lydicus is particularly suitable as a biocontrol agent that can be used to protect plants against infection by nematodes. Thus, Streptomyces lydicus is useful in methods for reducing an effect of a plant parasitic nematode population, reducing nematodes on a plant or seed in soil, maintaining a population of plant parasitic nematode below certain level, or protecting against nematode infection. As such, plants treated with Streptomyces lydicus will show reduced effects of nematode infection. In another aspect, Streptomyces lydicus is suitable as a fungicide. Useful Streptomyces bacteria strains have been described in U.S. Pat. Nos: 5,403,584 A, 5,527,526 A, and 5,968,503 A, all of which are incorporated herein by reference.

In one aspect, the inoculant comprises Streptomyces lydicus strain WYEC 108. In another aspect, Streptomyces lydicus is a filamentous bacterium that produces chains of spores in an aerial mycelium. In one aspect, Streptomyces lydicus did not produce melanin or H₂S on Peptone-Yeast-Iron Agar and Peptone-Iron Agar (Difco Lab. Detroit, Mich.), respectively. In one aspect, the color of the spore mass produced by Streptomyces lydicus on CYD plates was gray. In another aspect, Streptomyces lydicus did not grow at 45° C. In yet another aspect, Streptomyces lydicus colonizes plant roots in the presence of competition from rhizosphere microflora. In further aspect, Streptomyces lydicus is shown to reduce a population of plant parasitic nematode and enhance the growth of corn and soybean plants growing in an agricultural field.

In another aspect, a deposit of Streptomyces WYEC 108 was made under the terms of the Budapest Treaty with the American Type Culture Collection (ATCC), Rockville, Md., on Jun. 29, 1993. This strain has been designated ATCC Accession No. 55445. In one aspect, the Streptomyces lydicus strain WYEC 108 comprises strain ATCC 55445 or derivatives thereof.

In an aspect, the inoculant comprises vegetative cells of Streptomyces lydicus. In another aspect, the Streptomyces lydicus comprises spores. In yet another aspect, the inoculant comprises a mixture of vegetative cells of Streptomyces lydicus and spores thereof. In one aspect, the inoculant comprises at least 5, 10, 15, 20, 25, 30, 35, 40, 45, 50, 55, 60, 65, 70, 75, 80, 85, 90, 95%, or more (by weight) spores of Streptomyces lydicus. In another aspect, spores of Streptomyces lydicus are produced in liquid medium and directly incorporated into the preferred delivery medium which is then stored. In yet another aspect, spores of Streptomyces lydicus are produced in solid medium and mixed directly into the delivery medium.

In one aspect, the inoculant further comprises a delivery medium. In a particular aspect, the delivery medium may comprise alginate gel, peat moss, sand, cornmeal or a nitrogen source. In another aspect, the nitrogen source is ammonium chloride. The use of ammonium chloride in the delivery medium provides a nitrogen source of germinating spores of Streptomyces lydicus. It will be apparent to one skilled in the art that other nitrogen sources besides ammonium chloride can be used for this purpose. For example, when spores are resuspended in bacterial growth medium (such as 10% YGM) prior to incorporation in the delivery medium, the addition of this nitrogen source is unnecessary. In preferred aspects of the present specification, the delivery medium comprises a sufficient amount of a nitrogen source. It will be apparent to one skilled in the art that the determination of what comprises “a sufficient amount” of a nitrogen source can be made by determining the effects on germination frequency of increasing or decreasing the amount of a particular nitrogen source or the effects of changing the nitrogen source. A sufficient amount of a nitrogen source is that amount of a particular nitrogen source which facilitates germination of the spores of Streptomyces lydicus. In one aspect, the delivery medium comprises water. In one aspect, the inoculant is completely soluble and the delivery medium is water. In another aspect, the delivery medium comprises a chemical component comprising a 3,5-disubstituted-1,2,4-oxadiazole or a salt thereof.

In one aspect, the Streptomyces lydicus strain WYEC 108 further comprises iron. In another aspect, the Streptomyces lydicus strain WYEC 108 further comprises humate. In yet another aspect, the Streptomyces lydicus strain WYEC 108 further comprises iron and humate. In one aspect, the humate includes, without limitation, fulvic and humic acids.

In one aspect, the present specification encompasses a delivery medium which comprises peat moss, sand and cornmeal together with Streptomyces lydicus. In another aspect, the delivery medium comprises peat moss-sand-cornmeal in a 1:3.5:1 weight/weight ratio. In one aspect, the delivery medium comprises sand-water-cornmeal in a 9:2:1 weight/weight ratio. In one aspect, the delivery medium is sterilized by sterilization (including all sterilization methods known in the art, including heat, steam, and filter) prior to use. In another aspect, the delivery medium comprises at least 10⁵ colony forming units per gram of delivery medium. In a further aspect, Streptomyces lydicus is added to the delivery medium to a final concentration of at least 1×10⁵ cfu/g, at least 1×10⁶ cfu/g, at least 1×10⁷ cfu/g, or at least 1×10⁸ cfu/g. In yet another aspect, the inoculant comprising the vegetative cells and spores of Streptomyces lydicus and the delivery medium is shown to have a long shelf life and to be suitable for delivering Streptomyces lydicus to plants.

In further aspect, Streptomyces lydicus may be incorporated into a delivery medium for use in horticultural and agricultural settings. It will be understood by one skilled in the art that the formulation of the delivery medium will be dictated by the particular application for which the biocontrol agent is intended. For example, various organic and inorganic fillers such as clay, vermiculite, wheat bran, corn cobs or chitin can be added to the delivery medium. The ratio of components of a delivery medium will be determined on the basis of texture and physical properties required. For example, properties such as moisture holding ability, light weight for easy handling and transportation, porosity to provide space for mycelial and plant root growth and spread may be important. Alternatively, vegetative mycelia or spores of Streptomyces lydicus can be added to an alginate suspension to produce alginate-entrapped pellets on this strain. Methods of producing alginate pellets are known in the art and are described further in U.S. Pat. No. 4,668,512 to Lewis et al. Other ingredients, such as fertilizers, may also be incorporated into these pellets.

In another aspect, the present specification encompasses alginate gel pellets containing Streptomyces lydicus. Such pellets can be added directly to the roots of growing plants or to horticultural or agricultural soils to reduce damage to plants caused by plant parasitic nematodes.

In an aspect, the inoculant comprising Streptomyces lydicus is applied at a rate of 1×10², 5×10², 1×10³, 5×10³, 1×10⁴, 5×10⁴, 1×10⁵, 5×10⁵, 1×10⁶, 5×10⁶, 1×10⁷, 5×10⁷, or 1×10⁸ colony forming units per seed.

In another aspect, the inoculant comprising Streptomyces lydicus is applied at a rate of 1×10⁷, 5×10⁷, 1×10⁸, 5×10⁸, 1×10⁹, 5×10⁹, or 1×10¹⁹ spores per acre.

In an aspect, effective amount of an inoculant comprising Streptomyces lydicus is sufficient to cause a reduction of an effect of a population of plant parasitic nematode or other desired agricultural trait. The actual effective amount in absolute value depends on factors including, but not limited to, the size (e.g., the area, the total acreage, etc.) of the land for application with the inoculant, interactions between other active or inert ingredients.

Without being limited by any theory, the inoculant can in one aspect, activate symbiotic and developmental genes which results in a change in the root architecture or physiology of the plant. In another aspect, the inoculant drives the natural growth processes, which enhance crop performance.

Streptomyces lydicus can be applied as a seed treatment, soil application (drench or in furrow), cutting or bare rooted transplant dip, ornamental bulb crop soak or dusting treatment, foliar application for ornamentals, all greenhouse and nursery crops, landscape plants including tree seedlings for transplanting to the field and production agriculture crops. In one aspect, the Streptomyces lydicus is used as a bio-priming agent. The seed is coated with the Streptomyces lydicus and hydrated for a period of time at a particular temperature in moist conditions. The seeds are removed before radical emergence. The Streptomyces lydicus may multiply substantially on seed during bio-priming. The bio-priming process has potential advantages over simply coating seed with Streptomyces lydicus, such as a more rapid and uniform seedling emergence and may be useful under adverse soil conditions.

### Oxadiazole

In one aspect, the composition comprises a chemical component comprising a compound of Formula (IV) or a salt thereof

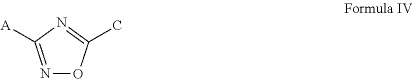

wherein,
A is phenyl, pyridyl, pyrazyl oxazolyl or isoxazolyl each of which can be optionally independently substituted with one or more substituents selected from: halogen, CF₃, CH₃, OCF₃, OCH₃, CN, C(H)O; and
C is thienyl, furanyl, oxazolyl or isoxazolyl each of which can be optionally independently substituted with one or more substituents selected from: fluorine, chlorine, CH₃, OCF₃.

In various embodiments: A is phenyl; A is pyridyl; A is pyrazyl; A is oxazolyl; A is isoxazolyl; C is thienyl; C is furanyl; C is oxazolyl; and C is isoxazolyl.

Also provided as compositions and disclosed are compounds having Formula IVa or a salt thereof,

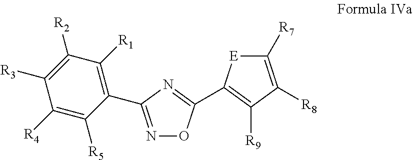

wherein,
R₁ and R₅ are independently selected from hydrogen, CH₃, F, Cl, Br, CF₃ and OCF₃, with the proviso that R₁ and R₅ cannot be simultaneously hydrogen
R₂ and R₄ are independently selected from hydrogen, F, Cl, Br, and CF₃.
R₃ is selected from hydrogen, CH₃, CF₃, F, Cl, Br, OCF₃, OCH₃, CN, and C(H)O.
R₇ and R₈ are independently selected from hydrogen and fluorine,
R₉ is selected from hydrogen, F, Cl, CH₃, and OCF₃.

### E is O or S.

In various embodiments of the compound of Formula IVa: R₁ and R₅ are independently selected from hydrogen and CH₃ with the proviso that R₁ and R₅ cannot be simultaneously hydrogen, R₃ is fluorine, chlorine or bromine, and E is O; R1 and R5 are independently selected from hydrogen and CH3 with the proviso that R1 and R5 cannot be simultaneously hydrogen, both R2 and R4 are hydrogen, R3 is chlorine or bromine, and E is O and R7, R8 and R9 are hydrogen; R₁ and R₅ are independently selected from hydrogen and CH₃ with the proviso that R₁ and R₅ cannot be simultaneously hydrogen, R₃ is fluorine, chlorine or bromine, E is S, and R₉ is hydrogen or fluorine; R₁ and R₅ are independently selected from hydrogen and CH₃ with the proviso that R₁ and R₅ cannot be simultaneously hydrogen, both R₂ and R₄ are hydrogen, R₃ is chlorine or bromine, E is O; R₁ and R₅ are independently selected from hydrogen and CH₃ with the proviso that R₁ and R₅ cannot be simultaneously hydrogen, both R₂ and R₄ are hydrogen, R₃ is chlorine or bromine, E is S, and R₉ is hydrogen or fluorine; R₁ and R₅ are independently selected from hydrogen and Cl, R₃ is fluorine, chlorine or bromine, E is O, and R₉ is fluorine.

Also provided as compositions and disclosed are compounds having Formula IVb or a salt thereof,

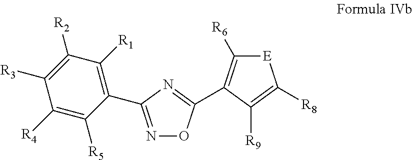

wherein,
R₁ and R₅ are independently selected from hydrogen, CH₃, F, Cl, Br, CF₃ and OCF₃; with the proviso that R₁ and R₅ cannot be simultaneously hydrogen
R₂ and R₄ are independently selected from hydrogen, F, Cl, Br, and CF₃;
R₃ is selected from hydrogen, CH₃, CF₃, F, Cl, Br, OCF₃, OCH₃, CN, and C(H)O;
R₈ is selected from hydrogen and fluorine;
R₆ and R₉ are independently selected from hydrogen, F, Cl, CH₃, and OCF₃; and

### E is O or S.

In various embodiments of the compound of Formula IVb: R₁ and R₅ are independently selected from hydrogen and CH₃ with the proviso that R₁ and R₅ cannot be simultaneously hydrogen, R₃ is fluorine, chlorine or bromine, and E is O; R₁ and R₅ are independently selected from hydrogen and CH₃ with the proviso that R₁ and R₅ cannot be simultaneously hydrogen, R₃ is fluorine, chlorine or bromine, E is S, and R₉ is hydrogen or fluorine; R₁ and R₅ are independently selected from hydrogen and CH₃ with the proviso that R₁ and R₅ cannot be simultaneously hydrogen, both R₂ and R₄ are hydrogen, R₃ is chlorine or bromine, E is O; R₁ and R₅ are independently selected from hydrogen and CH₃ with the proviso that R₁ and R₅ cannot be simultaneously hydrogen, both R₂ and R₄ are hydrogen, R₃ is chlorine or bromine, E is S, and R₉ is hydrogen or fluorine; and R₁ and R₅ are independently selected from hydrogen and Cl, R₃ is fluorine, chlorine or bromine, E is O, and R₉ is fluorine.

In one embodiment, the compound of Formula IV is 3,5-disubstituted-1,2,4-oxadiazole or a salt thereof.

Also provided as compositions and disclosed herein are compounds of Formula (V) or a salt thereof

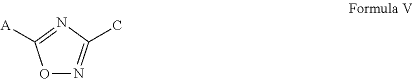

wherein,
A is phenyl, pyridyl, pyrazyl oxazolyl or isoxazolyl each of which can be optionally independently substituted with one or more with substituents selected from: halogen, CF₃, CH₃, OCF₃, OCH₃, CN, C(H)O; and
C is thienyl, furanyl, oxazolyl or isoxazolyl each of which can be optionally independently substituted with one or more with substituents selected from: fluorine, chlorine, CH₃, OCF₃.

In various embodiments: A is phenyl; A is pyridyl; A is pyrazyl; A is oxazolyl; A is isoxazolyl; C is thienyl; C is furanyl; C is oxazolyl; and C is isoxazolyl.

Also provided as compositions and disclosed are compounds having Formula Va or a salt thereof,

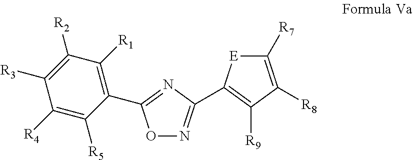

### Wherein,

R₁ and R₅ are independently selected from hydrogen, CH₃, F, Cl, Br, CF₃ and OCF₃; with the proviso that R₁ and R₅ cannot be simultaneously hydrogen
R₂ and R₄ are independently selected from hydrogen, F, Cl, Br, and CF₃;
R₃ is selected from hydrogen, CH₃, CF₃, F, Cl, Br, OCF₃, OCH₃, CN, and C(H)O;
R₇ and R₈ are independently selected from hydrogen and fluorine;
R₉ is selected from hydrogen, F, Cl, CH₃, and OCF₃; and

### E is O or S.

In various embodiments of the compound of Formula Va: R₁ and R₅ are independently selected from hydrogen and CH₃ with the proviso that R₁ and R₅ cannot be simultaneously hydrogen, R₃ is fluorine, chlorine or bromine, E is S, and R₉ is hydrogen or fluorine; R₁ and R₅ are independently selected from hydrogen and CH₃ with the proviso that R₁ and R₅ cannot be simultaneously hydrogen, both R₂ and R₄ are hydrogen, R₃ is chlorine or bromine, E is O; R₁ and R₅ are independently selected from hydrogen and CH₃ with the proviso that R₁ and R₅ cannot be simultaneously hydrogen, both R₂ and R₄ are hydrogen, R₃ chlorine or bromine, E is S, and R₉ is hydrogen or fluorine; R₁ and R₅ are independently selected from hydrogen and Cl, R₃ is fluorine, chlorine or bromine, E is O, and R₉ is fluorine.

Also provided as compositions and disclosed are compounds having Formula Vb or a salt thereof,

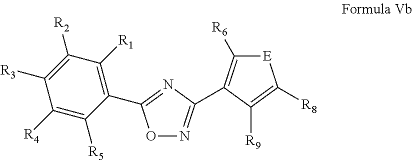

wherein,
R₁ and R₅ are independently selected from hydrogen, CH₃, F, Cl, Br, CF₃ and OCF₃;
R₂ and R₄ are independently selected from hydrogen, F, Cl, Br, and CF₃;
R₃ is selected from hydrogen, CH₃, CF₃, F, Cl, Br, OCF₃, OCH₃, CN, and C(H)O;
R₈ is selected from hydrogen and fluorine;
R₆ and R₉ are independently selected from hydrogen, F, Cl, CH₃, and OCF₃; and

### E is O or S.

In various embodiments of the compound of Formula Vb: R₁ and R₅ are independently selected from hydrogen and CH₃ with the proviso that R₁ and R₅ cannot be simultaneously hydrogen, R₃ is fluorine, chlorine and bromine, and E is O; R₁ and R₅ are independently selected from hydrogen and CH₃ with the proviso that R₁ and R₅ cannot be simultaneously hydrogen, R₃ is fluorine, chlorine or bromine, E is S and R₉ is hydrogen or fluorine; R₁ and R₅ are independently selected from hydrogen and CH₃ with the proviso that R₁ and R₅ cannot be simultaneously hydrogen, both R₂ and R₄ are hydrogen, R₃ is chlorine or bromine, E is O; R₁ and R₅ are independently selected from hydrogen and CH₃ with the proviso that R₁ and R₅ cannot be simultaneously hydrogen, both R₂ and R₄ are hydrogen, R₃ is chlorine or bromine, E is S, and R₉ is hydrogen or fluorine; R₁ and R₅ are independently selected from hydrogen and Cl, R₃ is fluorine, chlorine or bromine, E is O, and R₉ is fluorine.

Also described is a method of reducing an effect of a plant parasitic nematode population on a plant and a seed in soil comprising applying to the plant, soil, or seed in need thereof a composition comprising a chemical component selected from the group consisting of the compounds 3-phenyl-5-(thiophen-2-yl)-1,2,4-oxadiazole, 3-(4-fluorophenyl)-5-(thiophen-2-yl)-1,2,4-oxadiazole, 3-(4-chlorophenyl)-5-(furan-2-yl)-1,2,4-oxadiazole, 3-(4-chlorophenyl)-5-(thiophen-2-yl)-1,2,4-oxadiazole, 3-(4-chloro-2-methylphenyl)-5-(furan-2-yl)-1,2,4-oxadiazole, 5-(4-chloro-2-methylphenyl)-3-(furan-2-yl)-1,2,4-oxadiazole, 3-(4-bromo-2-methylphenyl)-5-(furan-2-yl)-1,2,4-oxadiazole, 3-(4-fluoro-2-methylphenyl)-5-(thiophen-2-yl)-1,2,4-oxadiazole, 3-(2,4-difluorophenyl)-5-(thiophen-2-yl)-1,2,4-oxadiazole, 3-(4-bromo-2-fluorophenyl)-5-(thiophen-2-yl)-1,2,4-oxadiazole, 5-(thiophen-2-yl)-3-(2,4,6-trifluorophenyl)-1,2,4-oxadiazole, 3-(2,4-dichlorophenyl)-5-(furan-2-yl)-1,2,4-oxadiazole, 3-(4-bromo-2-chlorophenyl)-5-(furan-2-yl)-1,2,4-oxadiazole, 3-(2-chloro-4-fluorophenyl)-5-(thiophen-2-yl)-1,2,4-oxadiazole, 3-(4-chlorophenyl)-5-(3-methylfuran-2-yl)-1,2,4-oxadiazole, 5-(furan-2-yl)-3-(4-methoxy-2-methylphenyl)-1,2,4-oxadiazole, 3-(4-chlorophenyl)-5-(thiophen-3-yl)-1,2,4-oxadiazole.

In various embodiments the composition further comprises an aqueous surfactant. Examples of surfactants that can be used include, Span 20, Span 40, Span 80, Span 85, Tween 20, Tween 40, Tween 80, Tween 85, Triton X 100, Makon 10, Igepal CO 630, Brij 35, Brij 97, Tergitol TMN 6, Dowfax 3B2, Physan and Toximul TA 15. In some cases, the nematicidal composition further includes a permeation enhancer (e.g., cyclodextrin). In some cases, the nematicidal composition further includes a co-solvent. Examples of co-solvents that can be used include ethyl lactate, methyl soyate/ethyl lactate co-solvent blends (e.g., Steposol), isopropanol, acetone, 1,2-propanediol, n-alkylpyrrolidones (e.g., the Agsolex series), a petroleum based-oil (e.g., aromatic 200) or a mineral oil (e.g., paraffin oil)). In some cases, the nematicidal composition further includes another pesticide (e.g., nematicide, insecticide or fungicide). Useful insecticides include, but are not limited to clothianidin, thiamethoxam, imidacloprid, cyantraniliprole, and chlorantraniliprole. Useful fungicides include, but are not limited to, silthiofam, fludioxonil, myclobutanil, azoxystrobin, trifloxystrobin, prothioconazole, fluoxastrobin, chlorothalonil, propiconazole, tebuconazole, ipconazole, fluopyram, fluxapyroxad, metalaxyl, mefenoxam and pyraclostrobin. Useful nematicides include, but are not limited to avermectins (e.g., ivermectin and abamectin), milbemycin, oxamyl, fenamiphos, fosthiazate, metam sodium. The composition may also comprise herbicides (e.g., glyphosate, glufosinate, dicamba, acetochlor, 2,4-D) and other chemicals for disease control (e.g., chitosan).

As used herein, the term “halo” or “halogen” refers to any radical of fluorine, chlorine, bromine or iodine.

The term “alkyl” as employed herein by itself or as part of another group refers to both straight and branched chain-radicals of up to ten carbons. Typical C1-10 alkyl groups include methyl, ethyl, propyl, isopropyl, butyl, sec-butyl, tert-butyl, 3-pentyl, hexyl and octyl groups, which may be optionally substituted.

The term “alkenyl” as employed herein by itself or as part of another group means a straight or branched chain radical of 2-10 carbon atoms, unless the chain length is limited thereto, including at least one double bond between two of the carbon atoms in the chain. Typical alkenyl groups include ethenyl, 1-propenyl, 2-propenyl, 2-methyl-1-propenyl, 1-butenyl and 2-butenyl.

The term “alkynyl” is used herein to mean a straight or branched chain radical of 2-10 carbon atoms, unless the chain length is limited thereto, wherein there is at least one triple bond between two of the carbon atoms in the chain. Typical alkynyl groups include ethynyl, 1-propynyl, 1-methyl-2-propynyl, 2-propynyl, 1-butynyl and 2-butynyl.

Alkoxy groups contain oxygen substituted by one of the C1-10 alkyl groups mentioned above, which may be optionally substituted.

Alkylthio groups contain sulfur substituted by one of the C1-10 alkyl groups mentioned above, which may be optionally substituted. Also included are the sulfoxides and sulfones of such alkylthio groups.

Amino groups include —NH₂, —NHR₁₅ and —NR₁₅R₁₆, wherein R₁₅ and R₁₆ are C1-10 alkyl or cycloalkyl groups, or R₁₅ and R₁₆ are combined with the N to form a ring structure, such as a piperidine, or R₁₅ and R₁₆ are combined with the N and other group to from a ring, such as a piperazine. The alkyl group may be optionally substituted.

The term “aryl” as employed herein by itself or as part of another group refers to monocyclic, bicyclic or tricyclic aromatic groups containing from 6 to 14 carbons in the ring.

Common aryl groups include C6-14 aryl, preferably C6-10 aryl. Typical C6-14 aryl groups include phenyl, naphthyl, phenanthrenyl, anthracenyl, indenyl, azulenyl, biphenyl, biphenylenyl and fluorenyl groups.

Cycloalkyl groups are C3-8 cycloalkyl. Typical cycloalkyl groups include cyclopropyl, cyclobutyl, cyclopentyl, cyclohexyl and cycloheptyl.

The term “arylalkyl” is used herein to mean any of the above-mentioned C1-10 alkyl groups substituted by any of the above-mentioned C6-14 aryl groups. Preferably the arylalkyl group is benzyl, phenethyl or naphthylmethyl.

The term “arylalkenyl” is used herein to mean any of the above-mentioned C2-10 alkenyl groups substituted by any of the above-mentioned C6-14 aryl groups.

The term “arylalkynyl” is used herein to mean any of the above-mentioned C2-10 alkynyl groups substituted by any of the above-mentioned C6-14 aryl groups.

The term “aryloxy” is used herein to mean oxygen substituted by one of the above-mentioned C6-14 aryl groups, which may be optionally substituted. Common aryloxy groups include phenoxy and 4-methylphenoxy.

The term “arylalkoxy” is used herein to mean any of the above mentioned C1-10 alkoxy groups substituted by any of the above-mentioned aryl groups, which may be optionally substituted. Example arylalkoxy groups include benzyloxy and phenethyloxy.

Example haloalkyl groups include C1-10 alkyl groups substituted by one or more fluorine, chlorine, bromine or iodine atoms, e.g., fluoromethyl, difluoromethyl, trifluoromethyl, pentafluoroethyl, 1,1-difluoroethyl, chloromethyl, chlorofluoromethyl and trichloromethyl groups.

Acylamino (acylamido) groups include any C1-6 acyl(alkanoyl) attached to an amino nitrogen, e.g., acetamido, chloroacetamido, propionamido, butanoylamido, pentanoylamido and hexanoylamido, as well as aryl-substituted C1-6 acylamino groups, e.g., benzoylamido, and pentafluorobenzoylamido.

Common acyloxy groups are any C1-6 acyl(alkanoyl) attached to an oxy (—O—) group, e.g., formyloxy, acetoxy, propionoyloxy, butanoyloxy, pentanoyloxy and hexanoyloxy.

The term heterocycle is used herein to mean a saturated or partially saturated 3-7 membered monocyclic, or 7-10 membered bicyclic ring system, which consists of carbon atoms and from one to four heteroatoms independently selected from the group consisting of O, N, and S, wherein the nitrogen and sulfur heteroatoms can be optionally oxidized, the nitrogen can be optionally quatemized, and including any bicyclic group in which any of the above-defined heterocyclic rings is fused to a benzene ring, and wherein the heterocyclic ring can be substituted on carbon or on a nitrogen atom if the resulting compound is stable.

Common saturated or partially saturated heterocyclic groups include tetrahydrofuranyl, pyranyl, piperidinyl, piperazinyl, pyrrolidinyl, imidazolidinyl, imidazolinyl, indolinyl, isoindolinyl, quinuclidinyl, morpholinyl, isochromanyl, chromanyl, pyrazolidinyl pyrazolinyl, tetronoyl and tetramoyl groups.

The term “heteroaryl” as employed herein refers to groups having 5 to 14 ring atoms; 6, 10 or 14π electrons shared in a cyclic array; and containing carbon atoms and 1, 2 or 3 oxygen, nitrogen or sulfur heteroactoms.

Example heteroaryl groups include thienyl(thiophenyl), benzo[b]thienyl, naphtho[2,3-b]thienyl, thianthrenyl, furyl(furanyl), pyranyl, isobenzofuranyl, chromenyl, xanthenyl, phenoxanthiinyl, pyrrolyl, including without limitation 2H-pyrrolyl, imidazolyl, pyrazolyl, pyridyl(pyridinyl), including without limitation 2-pyridyl, 3-pyridyl, and 4-pyridyl, pyrazinyl, pyrimidinyl, pyridazinyl, indolizinyl, isoindolyl, 3H-indolyl, indolyl, indazolyl, purinyl, 4H-quinolizinyl, isoquinolyl, quinolyl, phthalzinyl, naphthyridinyl, quinozalinyl, cinnolinyl, pteridinyl, carbazolyl, O-carbolinyl, phenanthridinyl, acrindinyl, perimidinyl, phenanthrolinyl, phenazinyl, isothiazolyl, phenothiazinyl, isoxazolyl, furazanyl, phenoxazinyl, 1,4-dihydroquinoxaline-2,3-dione, 7-aminoisocoumarin, pyrido[1,2-a]pyrimidin-4-one, pyrazolo[1,5-a]pyrimidinyl, including without limitation pyrazolo[1,5-a]pyrimidin-3-yl, 1,2-benzoisoxazol-3-yl, benzimidazolyl, 2-oxindolyl and 2-oxobenzimidazolyl. Where the heteroaryl group contains a nitrogen atom in a ring, such nitrogen atom may be in the form of an N-oxide, e.g., a pyridyl N-oxide, pyrazinyl N-oxide and pyrimidinyl N-oxide.

The term “heteroaryloxy” is used herein to mean oxygen substituted by one of the above-mentioned heteroaryl groups, which may be optionally substituted. Useful heteroaryloxy groups include pyridyloxy, pyrazinyloxy, pyrrolyloxy, pyrazolyloxy, imidazolyloxy and thiophenyloxy.

The term “heteroarylalkoxy” is used herein to mean any of the above-mentioned C1-10 alkoxy groups substituted by any of the above-mentioned heteroaryl groups, which may be optionally substituted.

A permeation enhancer is generally an agent that facilitates the active compounds of the present specification.

A co-solvent (i.e., a latent solvent or indirect solvent) is an agent that becomes an effective solvent in the presence of an active solvent and can improve the properties of the primary (active) solvent.

The composition can be produced in concentrated form that includes little or no water. The composition can be diluted with water or some other solvent prior to use to treat plants, seeds, soil or vertebrates.

The details of one or more aspects of the present specification are set forth in the accompanying drawings and the description below. Other features, objects, and advantages of the present specification will be apparent from the description and drawings, and from the claims.

### Compositions

Also described is a plant parasitic nematicidal composition comprising: (a) an inoculant comprising Streptomyces lydicus, and (b) a chemical component comprising a 3,5-disubstituted-1,2,4-oxadiazole or a salt thereof, where the composition is capable of reducing an effect of a first plant parasitic nematode population on a first plant or seed in soil relative to a second plant or seed in soil in need of reducing the effect of a second plant parasitic nematode population where the composition was not applied.

In one aspect, the inoculant and the chemical component are pre-mixed into the composition prior to use. In another aspect, the inoculant is applied to the first plant, seed, or soil prior to the chemical component. In another aspect, the chemical component is applied to the first plant, seed, or soil prior to the inoculant. In further aspect, the composition, the inoculant, or the chemical component is applied to the first plant, seed, or soil in an application selected from the group consisting of pellet application, drench application, and drip application.

In an aspect, the reduction of the effect of the first plant parasitic nematode population on the first plant or seed in soil by the composition is greater than a reduction of the effect of a third plant parasitic nematode population by the inoculant alone at the same colony forming unit as used in the composition on a third plant or seed in soil in need of reducing an effect of a third plant parasitic nematode population. In another aspect, the reduction of the first plant parasitic nematode population by the composition is at least 5, 10, 15, 20, 25, 30, 35, 40, 45, 50, 55, 60, 65, 70, 75, 80, 85, 90, 100, 150, 200, 300%, or more than the reduction of the third plant parasitic nematode population by the inoculant alone at the same colony forming unit.

In an aspect, the reduction of the effect of the first plant parasitic nematode population on the first plant or seed in soil by the composition is greater than a reduction of the effect of a fourth plant parasitic nematode population by the chemical component alone at the same concentration as used in the composition on a fourth plant or seed in soil in need of reducing an effect of a fourth plant parasitic nematode population. In another aspect, the reduction of the first plant parasitic nematode population by the composition is at least 5, 10, 15, 20, 25, 30, 35, 40, 45, 50, 55, 60, 65, 70, 75, 80, 85, 90, 100, 150, 200, 300%, or more than the reduction of the fourth plant parasitic nematode population by the chemical component alone at the same concentration.

In an aspect, the chemical component and the inoculant do not target the same population of plant parasitic nematode. In an aspect, the composition targets a larger population of plant parasitic nematode than does the inoculant alone. In an aspect, the composition targets a larger population of plant parasitic nematode than does the chemical component alone. In an aspect, the inoculant and the chemical component are compatible with one another and they act to consistently produce a greater reduction of an effect of a plant parasitic nematode population relative to the inoculant alone at the same colony forming unit or the chemical component alone at the same concentration. In an aspect, there is a surprising activity between the inoculant and the chemical component in terms of reducing an effect of a plant parasitic nematode population. In one aspect, the inoculant and the chemical component work to reduce a greater population of Meloidogyne incognita in corn plants or corn seeds than does the inoculant or the chemical component alone at the same colony forming unit or concentration, respectively. In another aspect, the inoculant and the chemical component work to reduce a greater population of Heterodera glycines in soybean plants or soybean seeds than does the inoculant or the chemical component alone at the same colony forming unit or concentration, respectively.

In one aspect, a composition is applied to a plant or a seed. In one aspect, the composition is applied as a seed coating. In another aspect, the composition is applied to a planted seed, for example, in soil. In another aspect, the composition is applied to a green, above ground tissue, of a plant. In another aspect, one or more compositions are applied to both the seed and a green tissue. In another aspect, different compositions are applied to green tissue and seeds of the same plant. Such applications can be at similar times or growth stages or at different growth stages or times.

In another aspect, the composition is applied to the seeds prior to planting. In another aspect, the composition is applied to the soil prior to planting. In another aspect, the composition is applied to the seeds at planting. In an aspect, the composition is provided to the seeds prior to the planting. In an aspect, the composition is applied to the soil prior to development stage V1. In an aspect, the composition is applied to the foliage of plants germinating from the container of seeds prior to development stage V1.

In an aspect, the applying of the composition is selected from the group consisting of coating the seeds with the composition prior to planting, applying the composition to the soil of the field prior to planting, applying the composition to the soil of the field at planting, applying the composition to the soil after planting, and applying the composition to the foliage of a plant growing in the field. In an aspect, the applying is applying the composition in-furrow. In an aspect, the applying is applying the composition to the population of seeds as a seed coating.

In one aspect the application of any composition or method step can be performed in its entirety by a farmer, a farm worker, a laborer, a seed distributor, an agrochemical company, an agricultural technology company, or any other parties similarly situated.

In an aspect any seed or plant can be treated or used. In one aspect, the seed or plant is selected from the group consisting of corn, soybean, cotton, wheat, buckwheat, safflower, sunflower, succulent, dry peas, peanuts, alfalfa, clover, vetch, trefoil, rye, rice, sorghum, millet, popcorn, sweet corn, Irish potatoes, sweet potatoes, cucurbit vegetables, including cucumbers, melons, gourds, squash, cantaloupe, and other cucurbits, canola, fruiting vegetables, including eggplant, sweet peppers, hot peppers, tomatoes, tomatillos, and other fruiting vegetables, leafy vegetables, including broccoli, brussel sprouts, cabbage, cauliflower, celery, collards, endive, kale, kohlrabi, lettuce, mustard greens, parsley, spinach and other leafy vegetable crops, lentils, edamame, tobacco plants, banana plants, and turf grasses.

In one aspect the seed is a soybean seed and the plant is a soybean plant. In one aspect, soybean includes Glycine max and includes all plant varieties that can be bred with soybean. In another aspect a soybean plant is a commercial plant available to farmers. In another aspect, a soybean plant or seed can be an elite seed or plant. In another aspect, a soybean plant can be a hybrid. In a further aspect a soybean plant can be an inbred.

In one aspect the seed is a corn seed and the plant is a corn plant. In one aspect, corn includes Zea mays and all plant varieties that can be bred with corn. In another aspect a corn plant is a commercial plant available to farmers. In another aspect, a corn plant or seed can be an elite seed or plant. In another aspect, a corn plant can be a hybrid. In a further aspect a corn plant can be an inbred.

In one aspect, the seed is a cotton seed and the plant is a cotton plant. In one aspect, cotton includes plants of the genus Gossypium in the family of Malvaceae and all plant varieties that can be bred with cotton. In another aspect a cotton plant is a commercial plant available to farmers. In another aspect, a cotton plant or seed can be an elite seed or plant. In another aspect, a cotton plant can be a hybrid. In a further aspect a cotton plant can be an inbred.

In one aspect, any appropriate plant part can be treated or used including plant organs (e.g., leaves, stems, roots, etc.), seeds, and plant cells and progeny of the same.

In another aspect, a composition can be in the form of a seed coating. Any appropriate seed coating can be used. In one aspect, liquid, slurry, a peat-based composition, or powder (e.g., wettable powder or a granular powder) form can be suitable for coating seeds. In one aspect, when used to coat seeds, the composition can be applied to the seeds and allowed to dry. In an aspect where the composition is a powder (e.g., a wettable powder or a granular powder), a liquid, such as water, can be added to the powder before application to a seed.

In another aspect, a treatment entails coating seeds with the at least two, three, four, five, or more compositions. One illustrative process involves coating the inside wall of a round container with the composition, adding seeds, then rotating the container to cause the seeds to contact the wall and the composition, a process known in the art as “container coating.” Seeds can be coated by combinations of coating methods. Soaking typically entails use of an aqueous solution containing the plant growth enhancing agent. For example, seeds can be soaked for about 1 minute to about 24 hours (e.g., for at least 1 min, 5 min, 10 min, 20 min, 40 min, 80 min, 3 hr, 6 hr, 12 hr, or 24 hr). In one aspect, soaking is typically carried out for about 1 minute to about 20 minutes.

In one aspect, a treatment is in the form of bio-priming with at least one inoculant comprising Streptomyces lydicus. In one aspect, bio-priming of seeds includes the following steps: pre-soak the seeds in water for 12 h; mix the inoculant comprising Streptomyces lydicus with the pre-soaked seeds at the rate of 10 g/kg seed; put the treated seeds in a heap; cover the heap with a moist jute sack to maintain high humidity; and incubate the seeds under high humidity for about 48 h at approximately 25-32° C. The inoculant comprising Streptomyces lydicus adhered to the seed grows on the seed surface under moist condition to form a protective layer all around the seed coat. A seed bio-primed with the inoculant comprising Streptomyces lydicus can for example provide protection against seed- and soil-borne plant pathogens, including plant parasitic nematodes, thereby improving germination and seedling growth and reducing the likelihood of very thick or thin plant stands.

In another aspect, bio-priming is performed in conjunction with a pelleting process to protect the primed seed. Without limitation, a seed pellet is a coating, usually of clay mixed with other inerts, that streamlines the size, shape, and uniformity of a small, non-round seed such as those of lettuce, carrots, onions, and many herbs and flowers. Pelleting can result in easier, safer, and more accurate mechanical seeding, thus reducing gaps in the field and the need for labor-intensive thinning. In one aspect, pelleting materials are somewhat permeable to oxygen and absorb water quickly so that the pellet splits immediately upon hydration.

In another aspect, seed sanitation techniques such as hot water treatment, chlorine treatment, etc may be used prior to seed treatment with Streptomyces lydicus. In one aspect, hot water can be used to treat seeds to eradicate seed-borne diseases, including for example those caused by plant parasitic nematodes. In one aspect, the procedure consists of: 1) warming the seed in 100° F. water; 2) heating the seed for 20-25 minutes, depending on the crop species, in a 122° F. water bath; 3) cooling the seed for 5 minutes in cold water; and 4) rapid drying. Precision in temperature and timing are important, as the seed embryo may be killed in hotter water or the disease incompletely eradicated in cooler water.In another aspect, bleach (sodium hypochlorite) can be used to surface-disinfest seeds as an alternative to hot water. Bleach will eliminate pathogens on the seed surface but will not eliminate pathogens beneath the seed coat.

In one aspect seeds can be stored after application of the composition. In one aspect, the effectiveness of the seed coating can be retained for at least 50, 60, 70, 80, 90%, or more 6 months after the coating of the seeds with the composition.

In one aspect a composition, including those comprising (a) an inoculant comprising Streptomyces lydicus, and (b) a chemical component comprising a 3,5-disubstituted-1,2,4-oxadiazole or a salt thereof, is capable of diffusing toward a young developing radical.

In one aspect, compositions containing (a) an inoculant comprising Streptomyces lydicus, and (b) a chemical component comprising a 3,5-disubstituted-1,2,4-oxadiazole or a salt thereof, can further contain a sticking or coating agent. In one aspect, compositions can further contain a coating polymer and/or a colorant.

In one aspect, at least two different compositions are applied to seeds (directly or indirectly) or to the plant via the same composition (that is, they are formulated together). In one aspect, at least two different compositions can be used. In one aspect, different compositions can be formulated separately, and both compositions are applied to a seed or a plant. In another aspect, a different composition is applied to seeds then is applied to different parts of the plants, for example, without limitation, green tissue.

In one aspect, seeds can be treated with the composition in multiple ways including, without limitation, via spraying or dripping, drenching, or pellet application. Spray and drip treatment can be conducted, for example, by formulating an effective amount of the composition in an agronomically acceptable carrier, typically aqueous in nature, and spraying or dripping the composition onto seed via a continuous treating system (which is calibrated to apply treatment at a predefined rate in proportion to the continuous flow of seed), such as a drum-type of treater. Such methods include those that can advantageously employ relatively small volumes of carrier so as to allow for relatively fast drying of the treated seed. Large volumes of seeds can be efficiently treated. Batch systems, in which a predetermined batch size of seed and signal molecule compositions are delivered into a mixer, can also be employed. Systems and apparatuses for performing these processes are commercially available from numerous suppliers, e.g., Bayer CropScience (Gustafson). In another aspect, the composition can be applied to the soil directly, e.g., drench application. In one aspect, pellet application can be conducted where the composition is combined with inert materials to form a slurry. The slurry is then compressed and extruded under pressure through a die and is cut at desired lengths to produce a particle that is relatively uniform in size and shape. Pellets are used in spot applications and can provide a high degree of safety to the applicator.

Treatment at the time of planting includes, without limitation, direct application to the seed and introducing the composition into the soil. Such treatments include, without limitation, furrow treatment. In an aspect, seeds can be then packaged, e.g., in 50-lb or 100-lb bags, or bulk bags or containers, in accordance with standard techniques. In an aspect, treated seeds can be stored for at least 1, 2, 3, 4, 5, 6, 7, 8, 9, 10, 11, or 12 months, and even longer, e.g., 13, 14, 15, 16, 17, 18, 19, 20, 21, 22, 23, 24, 25, 26, 27, 28, 29, 30, 31, 32, 33, 34, 35, 36 months, or even longer, under appropriate storage conditions which are known in the art.

In one aspect, a composition contains an effective amount of active ingredients. In one aspect an effective amount of composition is used to treat the seed, expressed in units of weight, the effective amount can be any amount but in one aspect ranges from about 1 to about 400 g/hundred weight (cwt) seed, and in another aspect from about 2 to about 70 g/cwt, and in a further aspect, from about 2.5 to about 3.0 g/cwt seed. In one aspect, the effective amount is at least about 2, 2.5, 2.6, 2.7, 2.8, 2.9, 3, 5, 10, 15, 20, 25, 30, 35, 40, 45, 50, 55, 60, 65, 70, 80, 90, 100, 150, 200, 250, 300, 350, 400 g/cwt, or more.

In one aspect, a seed treatment can be direct or indirect. For purposes of indirect treatment of seed, it can include, without limitation, an in-furrow treatment, an effective amount of which can be any effective amount of the composition, in one aspect, can range from 1 g/acre to about 70 g/acre, and in another aspect, from about 50 g/acre to about 60 g/acre. For purposes of direct application to the plants, an effective amount can be any effective amount, and in one aspect and for the composition can range from 1 g/acre to about 30 g/acre, and in a further aspect, from about 11 g/acre to about 20 g/acre.

In an aspect, the chemical component is present in an amount from about 10⁻² to 10⁻¹⁰ Molar. In another aspect, the chemical component is present in an amount of at least about 10⁻¹⁰, 5×10⁻¹⁰, 10⁻⁹, 5×10⁻⁹, 10⁻⁸, 5×10⁻⁸, 10⁻⁷, 5×10⁻⁷, 10⁻⁶, 5×10⁻⁶, 10⁻⁵, 5×10, 10⁻⁴, 5×10⁻⁴, 10⁻³, 5×10⁻³, or 10⁻² Molar.

In an aspect, the composition is present in an amount from 10⁻⁹ to 1 μg/seed. In another aspect, the composition is present in an amount of at least about 10⁻⁹, 5×10⁻⁹, 10⁻⁸, 5×10⁻⁸, 10⁻⁷, 5×10⁻⁷, 10⁻⁶, 5×10⁻⁶, 10⁻⁵, 5×10⁻⁵, 10⁻⁴, 5×10⁻⁴, 10⁻³, 5×10⁻³, 10⁻², 5×10⁻², 10⁻¹, 5×10⁻¹, or 1 μg/seed.

In an aspect, the composition is present in an amount from 1 g/container to 1 kg/container. In another aspect, the composition is present in an amount of at least about 1, 5, 10, 15, 20, 25, 30, 35, 40, 45, 50, 55, 60, 65, 70, 75, 80, 85, 90, 95, 100, 150, 200, 250, 300, 350, 400, 450, 500, 550, 600, 650, 700, 750, 800, 850, 900, 950, or 1000 g/container.

In an aspect, the composition is coated on the seed, where the composition is coated at a rate in a range of about 0.25 to 1 and in another aspect at a rate of about 0.5 fl ounces/cwt (0.9 mg/seed) of the composition.

In an aspect, the composition is applied in-furrow or to the soil of the field prior to planting at a rate in a range of about 8 to 16 ounces per acre.

In an aspect, the composition is at a concentration of at least about 8 ounce/acre, at least about 9 ounce/acre, at least about 10 ounce/acre, at least about 11 ounce/acre, at least about 12 ounce/acre, at least about 13 ounce/acre, at least about 14 ounce/acre, at least about 15 ounce/acre, or at least about 16 ounce/acre. In an aspect, the composition is at a concentration from about 8 to about 16 ounce/acre, from about 9 to about 16 ounce/acre, from about 10 to about 16 ounce/acre, from about 11 to about 16 ounce/acre, from about 12 to about 16 ounce/acre, from about 13 to about 16 ounce/acre, from about 14 to about 16 ounce/acre, or from about 15 to about 16 ounce/acre.

In an aspect, the composition is applied to the foliage of plant growing in the field at a rate of about 1, 2, 3, 4, 5, 6, 7, 8, 9, 10, 11, 12, 13, 14, 15, 16, 17, 18, 19, 20 or more ounces per acre. In one aspect a composition, including those comprising (a) an inoculant comprising Streptomyces lydicus, (b) a chemical component comprising a 3,5-disubstituted-1,2,4-oxadiazole or a salt thereof, and (c) a natural or non-naturally occurring pesticide or plant growth promoter or biological. In another aspect a composition, including those comprising (a) an inoculant comprising Streptomyces lydicus, (b) a chemical component comprising a 3,5-disubstituted-1,2,4-oxadiazole or a salt thereof, and (c) a second active selected from the group consisting of microorganisms, herbicides, fungicides, insecticides, nematicides, acaricides, fertilizers, chitinous compounds, LCO, flavonoids, jasmonic acid, linolenic acid, and karrikins.

### Microorganisms

In another aspect, microorganisms can be included in the compositions and methods disclosed herein. Examples of microbes include bacteria from the genera Rhizobium spp. (e.g., R. cellulosilyticum, R. daejeonense, R. etli, R. galegae, R. gallicum, R. giardinii, R. hainanense, R. huautlense, R. indigoferae, R. leguminosarum, R. loessense, R lupini, R. lusitanum, R. meliloti, R. mongolense, R. miluonense, R. sullae, R. tropici, R. undicola, and/or R. yanglingense), Bradyrhizobium spp. (e.g., B. bete, B. canariense, B. elkanii, B. iriomotense, B. japonicum, B. jicamae, B. liaoningense, B. pachyrhizi, and/or B. yuanmingense), Azorhizobium spp. (e.g., A. caulinodans and/or A. doebereinerae), Sinorhizobium spp. (e.g., S. abri, S. adhaerens, S. americanum, S. aboris, S. fredii, S. indiaense, S. kostiense, S. kummerowiae, S. medicae, S. meliloti, S. mexicanus, S. morelense, S. saheli, S. terangae, and/or S. xinjiangense), Mesorhizobium spp., (M. albiziae, M. amorphae, M. chacoense, M. ciceri, M. huakuii, M. loti, M. mediterraneum, M. pluifarium, M. septentrionale, M. temperatum, and/or M. tianshanense), and combinations thereof. In further aspect, the microorganism is applied at a rate of about 1×10², 5×10², 1×10³, 5×10³, 1×10⁴, 5×10⁴, 1×10⁵, 5×10⁵, 1×10⁶, 5×10⁶, 1×10⁷, 5×10⁷, or 1×10⁸ colony forming units per seed.

The composition can include a microorganism that improves organic P mobilization (phytase), nitrogen use efficiency, micronutrient availability, or is a phosphate solubilizing microorganism. In one aspect, the phosphate solubilizing microorganism includes, but is not limited to, the Penicillium genus. In one aspect, the composition does not include a phosphate solubilizing microorganism.

As used herein, the term of “phosphate solubilizing” is intended to mean the conversion of insoluble phosphate (e.g., rock phosphate, etc.) into a soluble phosphate form.

As used herein, “phosphate solubilizing microorganism” is a microorganism that is able to increase the amount of phosphorous available for a plant, including but not limited to, increasing phosphorous in the soil. Phosphate solubilizing microorganisms include fungal and bacterial microbial species. Non-limiting examples of phosphate solubilizing microorganisms include, without limitation, species from a genus selected from the group consisting of Acinetobacter, Arthrobacter, Arthrobotrys, Aspergillus, Azospirillum, Bacillus, Burkholderia, chryseomonas, Enterobacter, Eupenicillium, Exiguobacterium, Klebsiella, Kluyvera, Microbacterium, Mucor, Paecilomyces, Paenibacillus, Penicillium, Pseudomonas, Serratia, Stenotrophomonas, Streptomyces, Streptosporangium, Swaminathania, Thiobacillus, Torulospora, Vibrio, Xanthobacter, and Xanthomonas.

Non-limiting examples of phosphate solubilizing microorganisms can be also selected from the group consisting of Acinetobacter calcoaceticus, Acinetobacter sp, Arthrobacter sp., Arthrobotrys oligospora, Aspergillus niger, Aspergillus sp., Azospirillum halopraeferans, Bacillus amyloliquefaciens, Bacillus atrophaeus, Bacillus circulars, Bacillus licheniformis, Bacillus subtilis, Burkholderia cepacia, Burkholderia vietnamiensis, Candida krissii, Chryseomonas luteola, Enterobacter aerogenes, Enterobacter asburiae, Enterobacter sp., Enterobacter taylorae, Eupenicillium parvum, Exiguohacterium sp., Klebsiella sp., Kluyvera cryocrescens, Microbacterium sp., Mucor ramosissimus, Paecilomyces hepialid, Paecilomyces mar quandii, Paenibacillus macerans, Paenibacillus mucilaginosus, Pantoea aglomerans, Penicillium expansum, Pseudomonas corrugate, Pseudomonas fluorescens, Pseudomonas lutea, Pseudomonas poae, Pseudomonas putida, Pseudomonas stutzeri, Pseudomonas trivialis, Serratia marcescens, Stenotrophomonas maltophilia, Streptomyces sp., Streptosporangium sp., Swaminathania salitolerans, Thiobacillus ferrooxidans, Torulospora globosa, Vibrio proteolyticus, Xanthobacter agilis, and Xanthomonas campestris.

### Herbicides

As used herein, the term “herbicide(s)” means any agent or combination of agents capable of killing weeds and/or inhibiting the growth of weeds (the inhibition being reversible under certain conditions). Herbicides can be utilized in an aspect of the present specification. In one aspect, an herbicide can be used in combination with either a composition of the present specification or a part of a method of the present specification.

Suitable herbicides used in the compositions and methods disclosed herein include ACCase inhibitors (such as aryloxyphenoxyproprionates and cyclohexandiones), EPSPS inhibitors (glyphosate), glutamine synthetase inhibitors (glufosinate), synthetic auxins (such as benzoic acids, phenoxy and pyridine herbicides), photosystem II (PS II) inhibitors (such as ureas and triazines), ALS or AHAS inhibitors (such as sulfonyl ureas, triazolo pyrimidines and imidazolinones), photosystem I (PS I) inhibitors (such as bipyridyliums), protoporphyrinogen oxidase (PPO) inhibitors (such as dipenthyl ethers, phenylpyrazoles, oxadiazoles, triazolinones, N-phenylphthalimides, oxazolidinediones, benzoxazinones, pyrimidinediones, and thiadiazoles), mitosis inhibitors (such as dinitroanilines, pyridines, benzamides, and phosphoramidates), cellulose inhibitors (such as benzamides and nitriles), oxidative phosphorylation uncouplers (such as dinitrophenols), fatty acid and lipid biosynthesis inhibitors (such as thiocarbamates), auxin transport inhibitors (such as phthalamates and semicarbazones), carotenoid biosynthesis inhibitors (such as benzoylpyrazoles, benzoylcyclohexandiones, and isoxazolidinones), cell division inhibitors (inhibition of VLCFA such as acetamides, chloroacetamides, oxyacetamides and tetrazolinones) and 4-hydroxyphenylpyruvate dioxygenase inhibitors (HPPD inhibitors such as pyrazolones, triketones and diketonitriles)

In one aspect, the compositions described herein can further comprise one or more herbicides. Suitable herbicides include, without limitation, chemical herbicides, natural herbicides (e.g., bioherbicides, organic herbicides, etc.), or combinations thereof. Non-limiting examples of suitable herbicides include, without limitation, atrazine, quizalofop, haloxyfop, clethodim, glyphosate, glufosinate, dicamba, 2,4-D, triclopyr, metribuzin, halosulfuron, nicosulfuron, chlorimuron, cloransulam, diclosulam, imazethapyr, parquet, diquat, fomesafen, flumioxazin, carfentrazone, sulfentrazone, saflufenacil, ethyl 2-((3-(2-chloro-4-fluoro-5-(3-methyl-2,6-dioxo-4-(trifluoromethyl)-2,3-dihydropyrimidin-1 (6H)-yl)phenoxy)pyridin-2-yl)oxy)acetate, 1,5-dimethyl-6-thioxo-3-(2,2,7-trifluoro-3,4-dihydro-3-oxo-4-prop-2-ynyl-2H-1,4-benzoxazin-6-yl)-1,3,5-triazinane-2,4-dione (trifludimoxazin), pendimethalin, acetochlor, metolachlor, mesotrione, topramezone, tembotrione, and isoxaflutole. Commercial products containing each of these compounds are readily available. Herbicide concentration in the composition will generally correspond to the labeled use rate for a particular herbicide.

### Fungicide(s)

As used herein, the term “fungicide(s)” means any agent or combination of agents capable of killing fungi and/or inhibiting fungal growth. Fungicides can be utilized in an aspect of the present specification. In one aspect, fungicide can be used in combination with either a composition of the present specification or a part of a method of the present specification.

In one aspect, the compositions described herein can further comprise one or more fungicides. Fungicides useful to the compositions described herein will suitably exhibit activity against a broad range of pathogens, including but not limited to Phytophthora, Rhizoctonia, Fusarium, Pythium, Phomopsis, or Selerotinia and Phakopsora, and combinations thereof.

Non-limiting examples of useful fungicides include aromatic hydrocarbons, benzimidazoles, benzthiadiazoles, carboxamides, carboxylic acid amides, morpholines, phenylamides, phosphonates, quinone outside inhibitors (e.g. strobilurins), thiazolidines, thiophanates, thiophene carboxamides, and triazoles. Particular examples of fungicides include acibenzolar-S-methyl, azoxystrobin, benalaxyl, bixafen, boscalid, carbendazim, cyproconazole, dimethomorph, epoxiconazole, fludioxonil, fluopyram, fluoxastrobin, flutianil, flutolanil, fluxapyroxad, fosetyl-Al, ipconazole, isopyrazam, kresoxim-methyl, mefenoxam, metalaxyl, metconazole, myclobutanil, orysastrobin, penflufen, penthiopyrad, picoxystrobin, propiconazole, prothioconazole, pyraclostrobin, sedaxane, silthiofam, tebuconazole, thiabendazole, thifluzamide, thiophanate, tolclofos-methyl, trifloxystrobin, and triticonazole. In one aspect, the fungicides include fluopyram, ipconazole, metalaxyl, mefenoxam, myclobutanil, pyraclostrobin, propiconazole, trifloxystrobin, azoxystrobin, fluxapyroxad, and combinations thereof.

Non-limiting examples of commercial fungicides which can be suitable for the compositions disclosed herein include, without limitation, PROTÉGÉ, RIVAL or ALLEGIANCE FL or LS (Gustafson, Plano, Tex.), WARDEN RTA (Agrilance, St. Paul, Minn.), APRON XL, APRON MAXX RTA or RFC, MAXIM 4FS or XL (Syngenta, Wilmington, Del.), CAPTAN (Arvesta, Guelph, Ontario) and PROTREAT (Nitragin Argentina, Buenos Ares, Argentina). Active ingredients in these and other commercial fungicides include, but are not limited to, fludioxonil, mefenoxam, azoxystrobin and metalaxyl. Commercial fungicides are most suitably used in accordance with the manufacturer's instructions at the recommended concentrations.

### Insecticide(s)/Nematicide(s)/Acaricide(s)

As used herein, the term “insecticide(s)” means any agent or combination of agents capable of killing one or more insects and/or inhibiting the growth of one or more insects. Insecticides can be utilized in an aspect of the present specification. In one aspect, an insecticide, nematicide, or acaricide can be used in combination with either a composition of the present specification or a part of a method of the present specification.

As used herein, the term “nematicide(s)” means any agent or combination of agents capable of killing one or more nematodes and/or inhibiting the growth of one or more nematodes. Nematicides can be utilized in an aspect of the present specification.

As used herein, the term “acaricide(s)” means any agent or combination of agents capable of killing one or more acarids and/or inhibiting the growth of one or more acarids. Acaricides can be utilized in an aspect of the present specification.

In one aspect, the compositions described herein can further comprise one or more insecticides, acaricides, nematicides, or combinations thereof. Insecticides useful to the compositions described herein will suitably exhibit activity against a broad range of insects including, but not limited to, wireworms, cutworms, grubs, corn rootworm, seed corn maggots, flea beetles, chinch bugs, aphids, leaf beetles, stink bugs, and combinations thereof. The insecticides, acaricides, and nematicides described herein can be chemical or natural (e.g., biological solutions, such as fungal pesticides, etc.).

Non-limiting examples of insecticides and nematicides include carbamates, diamides, macrocyclic lactones, neonicotinoids, organophosphates, phenylpyrazoles, pyrethrins, spinosyns, synthetic pyrethroids, tetronic and tetramic acids. In an aspect, insecticides, acaricides, and nematicides include, without limitation, acrinathrin, alpha-cypermethrin, betacyfluthrin, cyhalothrin, cypermethrin, deltamethrin csfenvalcrate, etofenprox, fenpropathrin, fenvalerate, flucythrinat, fosthiazate, lambda-cyhalothrin, gamma-cyhalothrin, permethrin, tau-fluvalinate, transfluthrin, zeta-cypermethrin, cyfluthrin, bifenthrin, tefluthrin, eflusilanat, fubfenprox, pyrethrin, resmethrin, imidacloprid, acetamiprid, thiamethoxam, nitenpyram, thiacloprid, dinotefuran, clothianidin, imidaclothiz, chlorfluazuron, diflubenzuron, lufenuron, teflubenzuron, triflumuron, novaluron, flufenoxuron, hexaflumuron, bistrifluoron, noviflumuron, buprofezin, cyromazine, methoxyfenozide, tebufenozide, halofenozide, chromafenozide, endosulfan, fipronil, ethiprole, pyrafluprole, pyriprole, flubendiamide, chlorantraniliprole (Rynaxypyr), chlothianidin, cyazypyr, emamectin, emamectin benzoate, abamectin, ivermectin, milbemectin, lepimectin, tebufenpyrad, fenpyroximate, pyridaben, fenazaquin, pyrimidifen, tolfenpyrad, dicofol, cyenopyrafen, cyflumetofen, acequinocyl, fluacrypyrin, bifenazate, diafenthiuron, etoxazole, clofentezine, spinosad, triarathen, tetradifon, propargite, hexythiazox, bromopropylate, chinomethionat, amitraz, pyrifluquinazon, pymetrozine, flonicamid, pyriproxyfen, diofenolan, chlorfenapyr, metaflumizone, indoxacarb, chlorpyrifos, spirodiclofen, spiromesifen, spirotetramat, pyridalyl, spinctoram, acephate, triazophos, profenofos, oxamyl, spinetoram, fenamiphos, fenamipclothiahos, 4-{[(6-chloropyrid-3-yl)methyl](2,2-difluoroethyl)amino}furan-2(5H)-one, cadusaphos, carbaryl, carbofuran, ethoprophos, thiodicarb, aldicarb, aldoxycarb, metamidophos, methiocarb, sulfoxaflor, cyantraniliprole, and also products based on Bacillus firmus (1-1582, BioNeem, Votivo), and combinations thereof.

In particular aspects insecticides and nematicides include abamectin, aldicarb, aldoxycarb, bifenthrin, carbofuran, chlorantraniliprole, clothianidin, cyfluthrin, cyhalothrin, cypermethrin, cyantraniliprole, deltamethrin, dinotefuran, emamectin, ethiprole, fenamiphos, fipronil, flubendiamide, fosthiazate, imidacloprid, ivermectin, lambda-cyhalothrin, milbemectin, nitenpyram, oxamyl, permethrin, spinetoram, spinosad, spirodichlofen, spirotetramat, tefluthrin, thiacloprid, thiamethoxam, and thiodicarb. Suitable amounts of insecticides and nematicides for use according to the present specification are known in the art.

Non-limiting examples of commercial insecticides which can be suitable for the compositions disclosed herein include, without limitation, CRUISER® (Syngenta, Wilmington, Del.), GAUCHO® and PONCHO® (Gustafson, Plano, Tex.). Active ingredients in these and other commercial insecticides include, without limitation, thiamethoxam, clothianidin, and imidacloprid. Commercial insecticides are most suitably used in accordance with the manufacturer's instructions at the recommended concentrations.

In another aspect, corn seeds are treated with the compositions described herein further comprising fungicides and insecticides selected from the group consisting of cyantraniliprole, thiamethoxam, clothianidin, imidacloprid, sedaxane, azoxystrobin, fludioxonil, metalaxyl, mefenoxam, thiabenzole, prothioconazole, fluoxastrobin, fluxapyroxad, fluopyram, pyraclostrobin, Votivo, LCO, Penicillium bilaii, Bradyrhizobium japonicum, and combinations thereof.

Additional active components may also comprise substances such as, biological control agents, microbial extracts, natural products, plant growth activators or plant defense agents. Non-limiting examples of biological control agents include bacteria, fungi, beneficial nematodes, and viruses.

In certain aspects, the biological control agent can be a bacterium of the genus Actinomycetes, Agrobacterium, Arthrobacter, Alcaligenes, Aureobacterium, Azobacter, Beijerinckia, Brevibacillus, Burkholderia, Chromobacterium, Clostridium, Clavibacter, Comomonas, Corynebacterium, Curtobacterium, Enterobacter, Flavobacterium, Gluconobacter, Hydrogenophage, Klebsiella, Methylobacterium, Paenibacillus, Pasteuria, Phingobacterium, Photorhabdus, Phyllobacterium, Pseudomonas, Rhizobium, Serratia, Stenotrophomonas, Streptomyces, Variovorax, and Xenorhadbus. In particular aspects the bacteria is selected from the group consisting of Bacillus amyloliquefaciens, Bacillus cereus, Bacillus firmus, Bacillus lichenformis, Bacillus pumilus, Bacillus sphaericus, Bacillus subtilis, Bacillus thuringiensis, Bradyrhizobium japonicum, Chromobacterium suttsuga, Pasteuria nishizawae, Pasteuria penetrans, Pasteuria usage, Pseudomonas fluorescens, and Streptomyces lydicus.

In certain aspects the biological control agent can be a fungus of the genus Alternaria, Ampelomyces, Aspergillus, Aureobasidium, Beauveria, Colletotrichum, Coniothyrium, Gliocladium, Metarhisium, Muscodor, Paecilonyces, Penicillium, Trichoderma, Typhula, Ulocladium, and Verticilium. In particular aspects the fungus is Beauveria bassiana, Coniothyrium minitans, Gliocladium vixens, Metarhizium anisopliae, Muscodor albus, Paecilomyces lilacinus, Penicillium bilaii, Trichoderma polysporum, and Trichoderma vixens.

In further aspects the biological control agents can be plant growth activators or plant defense agents including, but not limited to harpin, Reynoutria sachalinensis, jasmonate, lipochitooligosaccharides, and isoflavones.

In an aspect, the insecticide is a microbial insecticide. In a more particular aspect, the microbial insecticide is a fungal insecticide. Non-limiting examples of fungal insecticides that can be used in the compositions disclosed herein are described in McCoy, C. W., Samson, R. A., and Coucias, D. G. “Entomogenous fungi. In “CRC Handbook of Natural Pesticides. Microbial Pesticides, Part A. Entomogenous Protozoa and Fungi.” (C. M. Inoffo, ed.), (1988): Vol. 5, 151-236; Samson, R. A., Evans, H. C., and Latge, J. P. “Atlas of Entomopathogenic Fungi.” (Springer-Verlag, Berlin) (1988); and deFaria, M. R. and Wraight, S. P. “Mycoinsecticides and Mycoacaricides: A comprehensive list with worldwide coverage and international classification of formulation types.” Biol. Control (2007), doi: 10.1016/j.biocontro1.2007.08.001.

In an aspect, non-limiting examples fungal insecticides that can be used in the compositions disclosed herein include, without limitation, species of Coelomycidium, Myiophagus, Coelemomyces, Lagenidium, Leptolegnia, Couchia, Sporodiniella, Conidiobolus, Entomophaga, Entomophthora, Erynia, Massospora, Meristacrum, Neozygites, Pandora, Zoophthora, Blastodendrion, Metschnikowia, Mycoderma, Ascophaera, Cordyceps, Torrubiella, Nectria, Hypocrella, Calonectria, Filariomyces, Hesperomyces, Trenomyces, Myriangium, Podonectria, Akanthomyces, Aschersonia, Aspergillus, Beauveria, Culicinomyces, Engyodontium, Fusarium, Gibellula, Hirsutella, Hymenostilbe, Isaria, Metarhizium, Nomuraea, Paecilomyces, Paraisaria, Pleurodesmospora, Polycephalomyces, Pseudogibellula, Sorosporella, Stillbella, Tetranacrium, Tilachlidium, Tolypocladium, Verticillium, Aegerita, Filobasidiella, Septobasidium, Uredinella, and combinations thereof.

Non-limiting examples of particular species that can be useful as a fungal insecticide in the compositions described herein include, without limitation, Trichoderma hamatum, Trichoderma hazarium, Alternaria cassiae, Fusarium lateritum, Fusarium solani, Lecanicillium lecanii, Aspergillus parasiticus, Verticillium lecanii, Metarhizium anisopliae, and Beauveria bassiana. In an aspect, the compositions disclosed herein can include any of the fungal insecticides provided above, including any combination thereof.

### Fertilizer(s)

As used herein, “fertilizer(s)” is intended to mean any material of natural or synthetic origin that is applied to soils or to plant tissues to supply one or more plant nutrients essential to the growth of plants. Fertilizers can be utilized in an aspect of the present specification. In one aspect, a fertilizer can be used in combination with either a composition of the present specification or a part of a method of the present specification.

Commercially available manufactured phosphate fertilizers are of many types. Some common ones are those containing rock phosphate, monoammonium phosphate, diammonium phosphate, monocalcium phosphate, super phosphate, triple super phosphate, and/or ammonium polyphosphate. By means of the present specification it may be possible to reduce the amount of these fertilizers applied to the soil while still maintaining the same amount of phosphorus uptake from the soil.

An organic fertilizer refers to a soil amendment derived from natural sources that guarantees, at least, the minimum percentages of nitrogen, phosphate, and potash. Non-limiting examples of organic fertilizers include, without limitation, plant and animal by-products, rock powders, seaweed, compositions, and conditioners. These are often available at garden centers and through horticultural supply companies. In particular the organic source of phosphorus is from bone meal, meat meal, animal manure, compost, sewage sludge, or guano, or combinations thereof.

### Chitinous Compounds

As used herein, “chitinous compounds” are intended to mean chitins and chitosans, which are major components of the cell walls of fungi and the exoskeletons of insects and crustaceans, are also composed of GlcNAc residues. In one aspect, a chitinous compound can be used in combination with, or be part of, either a composition of the present specification or a part of a method of the present specification.

Chitinous compounds include, without limitation, chitin, (IUPAC: N-[5-[[3-acetylamino-4,5-dihydroxy-6-(hydroxymethyl)oxan-2yl]methoxymethyl]-2-[[5-acetylamino-4,6-dihydroxy-2-(hydroxy methypoxan-3-yl]methoxymethyl]-4-hydroxy-6-(hydroxymethyl)oxan-3-ys]ethanamide), and chitosan, (IUPAC: 5-amino-6-[5-amino-6-[5-amino-4,6-dihydroxy-2(hydroxymethyl)oxan-3-yl]oxy-4-hydroxy-2-(hydroxymethyl) oxan-3-yl]oxy-2(hydroxymethyl)oxane-3,4-diol). These compounds can be obtained commercially, e.g., from Sigma-Aldrich, or prepared from insects, crustacean shells, or fungal cell walls. Methods for the preparation of chitin and chitosan are known in the art, and have been described, for example, in U.S. Pat. No. 4,536,207 (preparation from crustacean shells), Pochanavanich, et al., Lett. Appl. Microbiol. 35:17-21 (2002) (preparation from fungal cell walls), and U.S. Pat. No. 5,965,545 (preparation from crab shells and hydrolysis of commercial chitosan). Deacetylated chitins and chitosans can be obtained that range from less than 35% to greater than 90% deacetylation, and cover a broad spectrum of molecular weights, e.g., low molecular weight chitosan oligomers of less than 15 kD and chitin oligomers of 0.5 to 2 kD; “practical grade” chitosan with a molecular weight of about 15 kD; and high molecular weight chitosan of up to 70 kD. Chitin and chitosan compositions formulated for seed treatment are also commercially available. Commercial products include, without limitation, for example, ELEXA® (Plant Defense Boosters, Inc.) and BEYOND™ (Agrihouse, Inc.). Chitinous compounds can be utilized in an aspect of the present specification.

### LCO/Flavonoids/Jasmonic Acid/Linolenic Acid

In one aspect, a LCO, flavonoid, jasmonic acid or linolenic acid can be used in combination with, or be part of, either a composition of the present specification or part of a method of the present specification.

LCOs are a lipo-chitooligosaccharide compounds. LCOs included in the compositions and methods of the present specification provided include those, without limitation, that can be isolated, derived or obtained from any suitable non-natural source, including synthetic and partially synthetic, natural source or any combination thereof. LCOs for use in combination with a method or composition can be any LCO and are sometimes referred to as symbiotic nodulation (Nod) signals or Nod factors. LCO include those with an oligosaccharide backbone of β-1,4-linked N-acetyl-D-glucosamine (“GlcNAc”) residues with an N-linked fatty acyl chain condensed at the non-reducing end. LCOs differ in the number of GlcNAc residues in the backbone, in the length and degree of saturation of the fatty acyl chain, and in the substitutions of reducing and non-reducing sugar residues. See, e.g., Denarie, et al., Ann. Rev. Biochem. 65:503 (1996); Hamel, et al., Planta 232:787 (2010); Prome, et al., Pure & Appl. Chem. 70(1):55 (1998).

In one aspect, compositions of the present specification comprise one or more LCOs represented by the following structure:

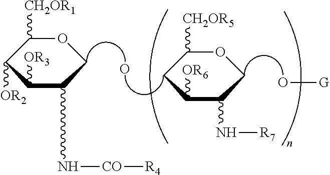

in which G is a hexosamine which can be substituted, for example, by an acetyl group on the nitrogen, a sulfate group, an acetyl group and/or an ether group on an oxygen; R₁, R₂, R₃, R₅, R₆ and R₇, which may be identical or different, represent H, CH₃ CO—, CₓH_{y}CO— where x is an integer between 0 and 17, and y is an integer between 1 and 35, or any other acyl group such as, for example, a carbamoyl; R₄ represents a saturated or mono-, di- or tri-unsaturated aliphatic chain containing at least 12 carbon atoms; and n is an integer between 1 and 4.

LCOs (and derivatives thereof) can be utilized in various forms of purity and can be used alone or in the form of a culture of LCO-producing bacteria or fungi. For example, OPTIMIZE® (commercially available from Monsanto Corporation) contains B. japonicum and LCO (including but not limited to LCO-V (C18:1, MeFuc); MOR116). LCOs may be recovered from microbial strains that produce LCOs, from microbial strains genetically engineered to produce LCOs and from microbial strains to which flavonoids have been added to stimulate LCO production as further described in U.S. Pat. No. 8,357,631. Methods to provide substantially pure LCOs include removing the microbial cells from a mixture of LCOs and the microbe, or continuing to isolate and purify the LCO molecules through LCO solvent phase separation followed by HPLC chromatography as described, for example, in U.S. Pat. No. 5,549,718. Purification can be enhanced by repeated HPLC, and the purified LCO molecules can be freeze-dried for long term storage. LCO can be purified or synthesized and provided to any composition in a pure or semi-pure form. In one aspect an LCO is provided in a form at least 20% pure, at least 30% pure, at least 40% pure, at least 50% pure, at least 60% pure, at least 65% pure, at least 70% pure, at least 75% pure, at least 80% pure, at least 85% pure, at least 90% pure, at least 91% pure, at least 92% pure, at least 93% pure, at least 94% pure, at least 95% pure, at least 96% pure, at least 97% pure, at least 98% pure, at least 99% pure, up to 100% pure. Additional methods to provide substantially pure LCOs include isolation and purification of chitooligosaccharides from microbial strains or genetically modified microbial strains, followed by synthesis to add the fatty acid component. It is to be understood that compositions and methods of the present specification can comprise analogues, derivatives, hydrates, isomers, salts, and/or solvates of LCOs.

Flavonoids are phenolic compounds having the general structure of two aromatic rings connected by a three-carbon bridge.

Classes of flavonoids include, without limitation, chalcones, anthocyanidins, coumarins, flavones, flavanols, flavonols, flavanones, and isoflavones. See, Jain, et al., J. Plant Biochem. & Biotechnol. 77:1-10 (2002); Shaw, et al., Environmental Microbiol. 77:1867-80 (2006).

As used herein, the term “isoflavonoids” means phytoestrogens, isoflavones (e.g., genistein, daidzein, glycitein, etc.), and isoflavanes (e.g., equol, lonchocarpane, laxiflorane, etc.). Isoflavonoids can be utilized in an aspect of the present specification. In one aspect, isoflavonoids can be used in combination with, or be part of, either a composition of the present specification or a part of a method of the present specification.

Representative flavonoids that can be useful in the practice of the present specification include, without limitation, genistein, daidzein, formononetin, naringenin, hesperetin, luteolin, and apigenin. Jasmonic acid (JA, [1 R-[1 a,2 (Z)]]-3-oxo-2-(pentenyl)cyclopentaneacetic acid) and its derivatives, linoleic acid ((Z,Z)-9,12-Octadecadienoic acid) and its derivatives, and linolenic acid ((Z,Z,Z)-9,12,15-octadecatrienoic acid) and its derivatives, can be used in the practice of the present specification. For example, REVV® and CUE® (commercially available from Monsanto Corporation) contain flavonoids. Jasmonic acid and its methyl ester, methyl jasmonate (MeJA), collectively known as jasmonates, are octadecanoid-based compounds that occur naturally in plants. Jasmonic acid may be produced by the roots of wheat seedlings, and by fungal microorganisms such as Botryodiplodia theobromae and Gibberella fujikuroi, yeast (Saccharomyces cerevisiae), and pathogenic and non-pathogenic strains of Escherichia coli. Jasmonates, linoleic acid and linoleic acid (and their derivatives) are reported to be inducers of nod gene expression or LCO production by rhizobacteria. See, e.g., Mabood, Fazli, “Jasmonates induce the expression of nod genes in Bradyrhizobium japonicum,” May 17, 2001; and Mabood, Fazli, “Linoleic and linolenic acid induce the expression of nod genes in Bradyrhizobium japonicum,” USDA 3, May 17, 2001.

Useful derivatives of linoleic acid, linolenic acid, and jasmonic acid that can be useful in the practice of the methods herein include, without limitation, esters, amides, glycosides and salts. Representative esters are compounds in which the carboxyl group of linoleic acid, linolenic acid, or jasmonic acid has been replaced with a —COR group, where R is an —OR¹ group, in which R¹ is: an alkyl group, such as a C₁-C₈ unbranched or branched alkyl group, e.g., a methyl, ethyl or propyl group; an alkenyl group, such as a C₂-C₈ unbranched or branched alkenyl group; an alkynyl group, such as a C₂-C₈ unbranched or branched alkynyl group; an aryl group having, for example, 6 to 10 carbon atoms; or a heteroaryl group having, for example, 4 to 9 carbon atoms, wherein the heteroatoms in the heteroaryl group can be, for example, N, O, P, or S. Representative amides are compounds in which the carboxyl group of linoleic acid, linolenic acid, or jasmonic acid has been replaced with a —COR group, where R is an NR²R³ group, in which R² and R³ are independently hydrogen; an alkyl group, such as a C₁-C₈ unbranched or branched alkyl group, e.g., a methyl, ethyl or propyl group; an alkenyl group, such as a C₂-C₈ unbranched or branched alkenyl group; an alkynyl group, such as a C₂-C₈ unbranched or branched alkynyl group; an aryl group having, for example, 6 to 10 carbon atoms; or a heteroaryl group having, for example, 4 to 9 carbon atoms, wherein the heteroatoms in the heteroaryl group can be, for example, N, O, P, or S. Esters can be prepared by known methods, such as acid-catalyzed nucleophilic addition, wherein the carboxylic acid is reacted with an alcohol in the presence of a catalytic amount of a mineral acid. Amides can also be prepared by known methods, such as by reacting the carboxylic acid with the appropriate amine in the presence of a coupling agent such as dicyclohexyl carbodiimide (DCC). Suitable salts of linoleic acid, linolenic acid, and jasmonic acid include, without limitation, e.g., base addition salts. The bases that can be used as reagents to prepare metabolically acceptable base salts of these compounds include those derived from cations such as alkali metal cations (e.g., potassium and sodium) and alkaline earth metal cations (e.g., calcium and magnesium). These salts can be readily prepared by mixing together a solution of linoleic acid, linolenic acid, or jasmonic acid with a solution of the base. The salt can be precipitated from solution and be collected by filtration or can be recovered by other means such as by evaporation of the solvent.

### Karrikins

Karrikins are vinylogous 4H-pyrones e.g., 2H-furo[2,3-c]pyran-2-ones. In one aspect, an Karrikins can be used in combination with, or be part of, either a composition of the present specification or a part of a method of the present specification. In one aspect, Karrikins include, without limitation, derivatives and analogues thereof. Examples of these compounds are represented by the following structure:

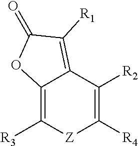

wherein; Z is O, S or NR₅; R₁, R₂, R₃, and R₄ are each independently H, alkyl, alkenyl, alkynyl, phenyl, benzyl, hydroxy, hydroxyalkyl, alkoxy, phenyloxy, benzyloxy, CN, COR₆, COOR═, halogen, NR₆R₇, or NO₂; and R₅, R₆, and R₇ are each independently H, alkyl or alkenyl, or a biologically acceptable salt thereof. Examples of biologically acceptable salts of these compounds can include, without limitation, acid addition salts formed with biologically acceptable acids, examples of which include, without limitation, hydrochloride, hydrobromide, sulphate or bisulphate, phosphate or hydrogen phosphate, acetate, benzoate, succinate, fumarate, maleate, lactate, citrate, tartrate, gluconate; methanesulphonate, benzenesulphonate and p-toluenesulphonic acid. Additional biologically acceptable metal salts can include, without limitation, alkali metal salts, with bases, examples of which include the sodium and potassium salts. Examples of compounds embraced by the structure and which can be suitable for use in the present specification include, without limitation, the following: 3-methyl-2H-furo[2,3-c]pyran-2-one (where R₁═CH₃, R₂, R₃, R₄═H), 2H-furo[2,3-c]pyran-2-one (where R₁, R₂, R₃, R₄═H), 7-methyl-2H-furo[2,3-c]pyran-2-one (where R₁, R₂, R₄═H, R₃═CH₃), 5-methyl-2H-furo[2,3-c]pyran-2-one (where R₁, R₂, R₃═H, R₄═CH₃), 3,7-dimethyl-2H-furo[2,3-c]pyran-2-one (where R₁, R₃═CH₃, R₂, R₄═H), 3,5-dimethyl-2H-furo[2,3-c]pyran-2-one (where R₁, R₄═CH₃, R₂, R₃═H), 3,5,7-trinnethyl-2H-furo[2,3-c]pyran-2-one (where R₁, R₃, R₄═CH₃, R₂═H), 5-methoxynnethyl-3-nnethyl-2H-furo[2,3-c]pyran-2-one (where R₁═CH3, R₂, R₃═H, R₄═CH₂OCH₃), 4-bromo-3,7-dimethyl-2H-furo[2,3-c]pyran-2-one (where R₁, R₃═CH₃, R₂═Br, R₄═H), 3-methylfuro[2,3-c]pyridin-2(3H)-one (where Z═NH, R₁═CH₃, R₂, R₃, R₄═H), 3,6-dimethylfuro[2,3-c]pyridin-2(6H)-one (where Z═N—CH₃, R₁═CH₃, R₂, R₃, R₄═H). See, U.S. Pat. No. 7,576,213. These molecules are also known as karrikins. See, Halford, supra. Karrikins can be utilized in an aspect of the present specification.

### Methods

In one aspect, the present specification provides growing a plant or a seed in soil with the composition where the composition is capable of reducing parasitic nematode population on the plant and the seed in soil.

In one aspect the soil is present in a field. A field can be any field. In one aspect, an area of land, enclosed or otherwise, is used for agricultural purposes such as cultivating crops. In one aspect, a field or area of land/soil for growing a crop or vegetable is greater than 100 square meters, 500 square meters, 1 acre, 5 acres, 10 acres, 20 acres, or 50 acres.

In one aspect, a plant in need of reducing an effect of a plant parasitic nematode population or reducing nematodes on a plant and a seed in soil is any crop, vegetable, or fruit. In one aspect, a plant can be corn, soybean, cotton, wheat, canola, cucurbits vegetables, fruiting vegetables, leafy vegetables, tobacco plants, banana plants, and turf grasses. In addition, the plant can be a corn plant. In another aspect, the plant can be a soybean plant. In one aspect, the plant can be a cotton plant.

In one aspect the reduction of a population of plant parasitic nematode is at least 5, 10, 15, 20, 25, 30, 35, 40, 45, 50, 55, 60, 65, 70, 75, 80, 85, 90, 95, or 100% for the plant, soil, or seed. In one aspect, the reduction of the population of plant parasitic nematode is measured on a single plant. In other aspects, the reduction of the population of plant parasitic nematode is measured on a group of plants where the group of plants is greater than 100, 200, 500, or 1000 plants. In one aspect, a reduction of a population of plant parasitic nematode is a capability of a provided composition or method.

In an aspect, the composition is capable of enhancing one or more characteristics selected from the group consisting of germination frequency, plant height, plant weight, days to maturity, and yield by at least 1, 2, 3, 4, 5, 10, 15, 20, 25, 30, 35, 40, 45, 50, 55, 60, 65, 70, 75, 80, 85, 90, 95, 100, 125, 150, 175, 200, 250, 300%, or more for a plant or seed in soil.

In another aspect, the present specification includes a method of reducing an effect of a parasitic nematode population on a plant or seed in soil comprising applying to the plant, soil, or seed a composition comprising: (a) an inoculant comprising Streptomyces lydicus, and (b) a chemical component comprising a 3,5-disubstituted-1,2,4-oxadiazole or a salt thereof.

In another aspect, the composition is capable of reducing the effect of the parasitic nematode population on the plant or seed in soil relative to a plant or seed in soil where the composition was not applied.

Also provided is a method of reducing an effect of a first plant parasitic nematode population on a first plant and a seed in soil comprising applying to the first plant, soil, or seed a composition comprising an inoculant comprising Streptomyces lydicus, where the composition is capable of reducing the effect of the first population of plant parasitic nematode relative to a second plant parasitic nematode population where the composition was not applied to a second plant, soil, or seed.

As used herein, “a plant” means a population of plants grown in a field that produces a crop.

As used herein, “an effect of a plant parasitic nematode population” means any adverse effect or damage the parasitic nematode population may cause to the plant or seed in soil.

In one aspect, “applying” or “applied” can be performed by any person but, without limitation, can be performed in its entirety by a farmer, a farm worker, a laborer, a seed distributor, an agrochemical company, an agricultural technology company, or any other parties similarly situated. In one aspect, the composition is applied to the first plant, soil, or seed in need thereof.

In one aspect, the method comprises providing a person with the seed and the composition. In one aspect, the method comprises providing a person with the composition. In one aspect, the method comprises growing the plant from the seed in the soil with the composition. In one aspect, the method comprises treating the seed with the composition and providing the treated seed to a farmer for growing in a field. In one aspect, the method comprises planting the seed in the soil. In one aspect, the method comprises immersing the seed in the composition and planting the seed in a field.

Also described is a method for reducing an effect of a plant parasitic nematode (e.g., nematodes other than C. elegans), the method including applying to plants, seeds, or soil the composition described herein. In some aspects, the nematode infects plants and the composition is applied to the soil or to plants. In some aspects, the composition is applied to soil before planting. In some aspects, the composition is applied to soil after planting. In some aspects, the composition is applied to soil using a drip system. In some aspects, the composition is applied to soil using a drench system. In some aspects, the composition is applied to soil using a pellet formulated with the composition. In some aspects, the composition is applied to plant roots or plant foliage (e.g., leaves, stems). In some aspects the composition is tilled into the soil or applied in furrow. In some aspects, the composition is applied to seeds. In some aspects, the composition is formulated for topical applications such as pour-ons, or for the use in tags or collars. Such methods can include contacting the nematode (at any stage of growth) with the composition as described therein.

As used herein, the term “nematode” refers to multicellular animals in the phylum Nematoda.

As used herein, the term “plant parasitic nematode” refers to nematode parasites of plants which can be found in/on plant roots, seeds, flowers, leaves, stems, or the soil in which the plant is growing. In another aspect, plant parasitic nematodes feed on all parts of the plant, including roots, stems, leaves, flowers and seeds. In one aspect, plant parasitic nematodes feed deep within the roots using their long stylets. In another aspect, plant parasitic nematodes feeds on the exterior of the root or partially burrows into the root to feed using its short stout stylet. Members of the family Heteroderidae are sedentary parasites that form elaborate permanent associations with the target host organism. They deprive nutrients from cells of an infected organism through a specialized stylet. The cyst nematodes (genera Heterodera and Globodera) and root-knot nematodes (genus Meloidogyne), in particular, cause significant economic loss in plants, especially crop plants. Examples of cyst nematodes include, inter alia, H. avenae (cereal cyst nematodes), H. glycines (beet cyst nematode) and G. pallida (potato cyst nematode). Root-knot nematodes include, for example, M. javanica, M. incognita and M. arenaria. Root-knot nematodes form galls or knots on the roots that block the flow of nutrients and photosynthesis products and their eggs can lay dormant in the soil for years. These pathogens establish “feeding sites” in the plant, by causing the morphological transformation of root cells into giant cells. Hence, nematode “infection” refers to invasion of and feeding upon the tissues of the host plant. Other nematodes that cause significant damage include the lesion nematodes such as Pratylenchus, particularly P. penetrans, which infects maize, rice and vegetables, P. brachyurus which infects pineapple and P. thornei which infects, inter alia, wheat.

In one aspect, plant parasitic nematode includes microorganisms from the genera Pratylenchus, Heterodera, Globodera, Meloidogyne, Rotylenchulus, Hoplolaimus, Belonolaimus, Longidorus, Paratrichodorus, Ditylenchus, Xiphinema, Helicotylenchus, Radopholus, Hirschmanniella, Tylenchorhynchus, and Trichodorus. In another aspect, the plant parasitic nematode is Meloidogyne incognita, or “root knot nematode.” In one aspect, Meloidogyne incognita infects corn plants, including corn leaves, corn stems, corn seeds, and corn roots. In yet another aspect, the plant parasitic nematode is Heterodera glycines, or “soybean cyst” nematode. In one aspect, Heterodera glycines infects soybean plants, including soybean leaves, soybean stems, soybean seeds, and soybean roots.

As used herein, the term “a population of plant parasitic nematode” refers to a group of plant parasitic nematode of one species that feed on the same plant, soil, or seed at the same time. In one aspect, “a population of plant parasitic nematode” means at least 100, 200, 500, 1000, 5000, 10,000, 50,000, 100, 000, 500,000, 1,000,000 of plant parasitic nematodes, or more. In one aspect, the plant parasitic nematode inhabits within plant roots. In one aspect, the plant parasitic nematode inhabits the thin film of moisture around soil particles. In another aspect, the plant parasitic nematode inhabits the rhizosphere soil around small plant roots and root hairs. In one aspect, the plant parasitic nematode inhabits the above-ground portions of plants, including leaves, flowers, and stems. In another aspect, the plant parasitic nematode can remain on the outside of the plant or can enter into leaf or stem tissues.

As used herein, the terms “first” or “second” population of plant parasitic nematode refers to two populations of plant parasitic nematode of one species in different plants, soil, or seeds, where the first population of plant parasitic nematode is applied with the composition of the present specification and the second population of plant parasitic nematode is not applied with the composition of the present specification.

As used herein, the terms “first” or “second” plant, soil, or seed refers to two sets of plant, soil, or seed in an approximate location and grown or managed under similar conditions, where the first plant, soil, or seed is applied with the composition of the present specification and the second plant, soil, or seed is not applied with the composition of the present specification.

In an aspect, the method further comprises applying one or more compositions selected from the group consisting of one or more agronomically beneficial elements to the soil, one or more agronomically beneficial elements to the seed, one or more agronomically beneficial elements to the plant that germinates from the seed, one or more lipo-chitooligosaccharides, one or more chitooligosaccharides, one or more chitinous compounds, one or more isoflavonoids, jasmonic acid or derivatives thereof, linolenic acid or derivatives thereof, linoleic acid or derivatives thereof, one or more karrakins, one or more pesticides, one or more fertilizers, and any combination of the above compositions.

In an aspect, the present specification includes a method comprising providing to a person a first container of seeds and a composition comprising: (a) an inoculant comprising Streptomyces lydicus, and (b) a chemical component comprising a 3,5-disubstituted-1,2,4-oxadiazole or a salt thereof, where the composition is capable of reducing a first population of plant parasitic nematode for a first population of plants germinating from the first container of seeds relative to a second population of plant parasitic nematode for a second population of plants grown in a comparable field from a second container of seeds where the composition was not provided.

As used herein, the term “a person” is intended to mean a farmer, a farm worker, a laborer, or any other parties similarly situated. In one aspect, a method can be carried out by a person in need thereof.

In an aspect, “providing” could be performed in its entirety by a farmer, a farm worker, a laborer, a seed distributor, an agrochemical company, an agricultural technology company, or any other parties similarly situated.

As used herein, the term “comparable field” is intended to mean a field in an approximate location to the field applied with the composition, grown in essentially similar soil and weather conditions as the field applied with the composition, and planted with similar seeds under the same management and treatments as the field applied with the composition.

In yet another aspect, the present specification includes a method of reducing a first plant parasitic nematode population for a first plant, soil, or a seed comprising growing the first plant from the first seed in the first soil with a composition comprising: (a) an inoculant comprising Streptomyces lydicus, and (b) a chemical component comprising a 3,5-disubstituted-1,2,4-oxadiazole or a salt thereof, where the composition is capable of reducing the first plant parasitic nematode population for the first plant, soil, or seed relative to a second plant, soil, or seed in need of reducing a second plant parasitic nematode population without the composition.

In an aspect, “growing” could be performed in its entirety by a farmer, a farm worker, a laborer, or any other parties similarly situated.

In an aspect, the composition is coated to the first seed prior to planting. In an aspect, the composition is applied to the first soil prior to planting. In an aspect, the composition is applied to the first soil at planting. In an aspect, the composition is applied to the first seeds at planting. In an aspect, the composition is applied to the first soil after planting. In an aspect, the composition is applied to the foliage of the first plants.

In an aspect, the present specification includes a method comprising growing a first population of plants from a first container of seeds, where the seeds are planted in soil with a composition comprising an inoculant comprising Streptomyces lydicus and a chemical component comprising a 3,5-disubstituted-1,2,4-oxadiazole or a salt thereof, where the composition is capable of increasing a yield of the first population of plants relative to a second population of plants, soil, or a second container of seeds grown in a comparable field without the composition.

In an aspect, the present specification includes a method comprising growing a first population of plants from a first container of seeds, where the seeds are planted in soil with a composition comprising an inoculant comprising Streptomyces lydicus and a chemical component comprising a 3,5-disubstituted-1,2,4-oxadiazole or a salt thereof, and second chemical component selected from the group consisting of an insectice, nematicide, fungicide, or biological. In another aspect, the present specification includes a method comprising growing a first population of plants from a first container of seeds, where the seeds are planted in soil with a composition comprising an inoculant comprising Streptomyces lydicus and a chemical component comprising a 3,5-disubstituted-1,2,4-oxadiazole or a salt thereof, and second chemical component selected from the group consisting of cyantraniliprole, thiamethoxam, sedaxane, azoxystrobin, fludionxinil, fluopyram, metalaxyl, mefenoxam, ipconazole, thiabendazole, clothianidin, prothiconazole, fluoxastrobin, fluxapyroxad, flyopyram, imidacloprid, pyraclostrobin, trifloxystrobin, and Bacillus firmus.

As used herein, “a container of seeds” is any object capable of holding seeds available in the art. By way of non-limiting example, a container of seeds may be a box, a bag, a bunch, a can, a packet, a pouch, a tape roll, a pail, a foil, a flat, or a tube.

As used herein, “a container of seeds” may contain any number, weight or volume of seeds. For example, a container can contain at least, or greater than, about 10, 25, 50, 75, 100, 200, 300, 400, 500, 600, 700, 800, 900, 1000, 1500, 2000, 2500, 3000, 3500, 4000, 4500, 5000 or more seeds. Alternatively, the container can contain at least, or greater than, about 1 ounce, 5 ounces, 10, ounces, 1 pound, 2 pounds, 3 pounds, 4 pounds, 5 pounds, or more seeds. In one aspect, the container can contain at least 5 pounds, 10 pounds, 25 pounds, 50 pounds, 100 pounds, or more seeds. In another aspect, the container of seeds can contain about 1, 5, 10, 15, 20, 25, 50, 100, 250, 500, 1000 or more grams of seeds. In another embodiment, a container of seeds has a composition comprising: (a) an inoculant comprising Streptomyces lydicus, and (b) a chemical component comprising a 3,5-disubstituted-1,2,4-oxadiazole or a salt thereof, in which at least 10%, 20%, 30%, 40%, 50%, 60%, 70%, 80%, 90%, or 100% of the seeds are provided with the composition.

As used herein, “a population” means at least 100 plants, 200 plants, 500 plants, 1000 plants, 5000 plants, 10,000 plants, 50,000 plants, 100, 000 plants, or more. In an aspect, a population of corn plants can be planted at least 1000 plants/acre, 5000 plants/acre, 10,000 plants/acre, 20,000 plants/acre, 50,000 plants/acre, 100,000 plants/acre, or more. In another aspect, a population of soybean plants can be planted at least 10,000 plants/acre, 20,000 plants/acre, 50,000 plants/acre, 100,000 plants/acre, 200,000 plants/acre, or more. In one aspect, a population of wheat plants can be planted at least 500,000 plants/acre. In further aspect, a population of cotton can be planted at least 50,000 plants/acre. A person of ordinary skill in the art would understand the planting density for the plants referenced in the present specification.

As used herein, the term “yield” refers to the amount (e.g., as determined by weight or size) or quantity (e.g., numbers) of tissues or organs produced per plant or per growing season. Increased yield of a plant can affect the economic benefit one can obtain from the plant in a certain growing area and/or growing time. Yield includes, without limitation, the number of bushels of soybeans or corn harvested at maturity from an acre. Yield also includes, without limitation, soybeans or corn harvested at maturity and expressed as a weight per unit area of cultivation. In one aspect, the yield is measured by cellulose content, oil content, starch content and the like. In one aspect, the yield is measured by oil content. In one aspect, the yield is measured by protein content. In one aspect, the yield is measured by seed number, seed weight, fruit number or fruit weight per plant or part thereof (e.g., kernel, bean). A plant yield can be affected by various parameters including, but not limited to, plant biomass; plant vigor; plant growth rate; seed yield; seed or grain quantity; seed or grain quality; oil yield; content of oil, starch and/or protein in harvested organs (e.g., seeds or vegetative parts of the plant); number of flowers (e.g. florets) per panicle (e.g. expressed as a ratio of number of filled seeds over number of primary panicles); harvest index; number of plants grown per area; number and size of harvested organs per plant and per area; number of plants per growing area (e.g. density); number of harvested organs in field; total leaf area; carbon assimilation and carbon partitioning (e.g. the distribution/allocation of carbon within the plant); resistance to shade; number of harvestable organs (e.g. seeds), seeds per pod, weight per seed; and modified architecture (such as increase stalk diameter, thickness or improvement of physical properties (e.g. elasticity)). An increase in corn yield can be measured as a percentage increase in bushels per acre, which is proportional to a percentage increase in ear number, average row number, and average kernel number. An increase in soybean yield can be measured as a percentage increase in bushels per acre, which is proportional to a percentage increase in pod number, seeds per pod, and seed size.

In an aspect, the yield from the first population of plants is enhanced by at least 5, 10, 15, 20, 25, 30, 35, 40, 45, 50, 55, 60, 65, 70, 75, 80, 85, 90, 95, 100, 125, 150, 175, 200, 250, 300%, or more relative to a yield from the second population of plants.

An aspect of the present specification includes a method comprising: (a) treating a first container of seeds with a composition comprising an inoculant comprising Streptomyces lydicus and a chemical component comprising a 3,5-disubstituted-1,2,4-oxadiazole or a salt thereof, and (b) providing the treated first container of seeds to a farmer for growing in a field, where the composition is capable of reducing a first plant parasitic nematode population for a first population of plants germinating from the first container of seeds relative to a second plant parasitic nematode population for a second population of plants in a comparable field germinating from a second container of seeds where the composition was not applied.

In an aspect, the treating with the composition is applying the composition as a seed coating.

In an aspect, “treating” can be performed in its entirety by a farmer, a farm worker, a laborer, a seed distributor, an agrochemical company, an agricultural technology company, or any other parties similarly situated.

In an aspect, the “providing” can be performed in its entirety by a farmer, a farm worker, a laborer, a seed distributor, an agrochemical company, an agricultural technology company, or any other parties similarly situated.

Another aspect of the present specification includes a method of reducing a first plant parasitic nematode population for a first plant, soil, or a seed comprising: (a) planting the first seed in the first soil; (b) applying a composition comprising an inoculant comprising Streptomyces lydicus and a chemical component comprising a 3,5-disubstituted-1,2,4-oxadiazole or a salt thereof to the first plant germinating from the first seed or to the first soil, where the composition is capable of reducing the first population of plant parasitic nematode in the first plant, soil, or seed relative to a second plant, soil, or seed in need of reducing a second plant parasitic nematode population where the composition was not applied.

In an aspect, the “planting” and “applying” can be performed in its entirety by a farmer, a farm worker, a laborer, or any other parties similarly situated.

A further aspect of the present specification includes a method of protecting against nematode infection for a first plant, soil, or a seed, the method comprising: (a) providing a composition comprising an inoculant comprising Streptomyces lydicus and a chemical component comprising a 3,5-disubstituted-1,2,4-oxadiazole or a salt thereof, and (b) applying the composition to the first plant, soil, or seed where the composition is capable of protecting the first plant against plant parasitic nematode infection relative to a second plant, soil, or seed in need of protecting against nematode infection where the composition was not applied.

In one aspect, the composition prevents the plant parasitic nematode from hatching in the soil. In one aspect, the composition prevents the plant parasitic nematode from locating, penetrating, or migrating within the plant roots. In one aspect, the composition inhibits the plant parasitic nematode from selecting a host and committing to a sedentary lifestyle. In one aspect, the composition kills the eggs and second stage juvenile nematodes (J2). In one aspect, the composition results in reduced population of the plant parasitic nematode.

In one aspect, the “providing” and “applying” can be performed in its entirety by a farmer, a farm worker, a laborer, a seed distributor, an agrochemical company, an agricultural technology company, or any other parties similarly situated.

A further aspect of the present specification includes a method for reducing the susceptibility to nematode infections or enhancing the germination frequency for a first seed, the method comprises: (a) immersing the first seed in a composition comprising an inoculant comprising Streptomyces lydicus and a chemical component comprising a 3,5-disubstituted-1,2,4-oxadiazole or a salt thereof, and (b) planting the first seed in a field, where the composition is capable of reducing the susceptibility to nematode infections or enhancing the germination frequency of the first seed relative to a second seed in need of reducing the susceptibility to nematode infections or enhancing the germination frequency where the composition was not immersed.

As used herein, the term “susceptibility” refers to the extent to which a plant would be infected by a plant parasitic nematode if exposed to without regard to the likelihood of exposure.

In one aspect, the seeds immersed in the composition develop at least partial resistance to a nematode infection when grown into a plant.

In one aspect, the seeds can be immersed in a solution containing an effective amount of the composition for about 1 minute to about 24 hours (e.g., for at least 1 min, 5 min, 10 min, 20 min, 40 min, 80 min, 3 hr, 6 hr, 12 hr, or 24 hr). In one aspect, immersing is typically carried out for about 1 minute to about 20 minutes.

In one aspect, the “immersing” can be performed in its entirety by a farmer, a farm worker, a laborer, a seed distributor, an agrochemical company, an agricultural technology company, or any other parties similarly situated.

In an aspect, “planting” could be performed in its entirety by a farmer, a farm worker, a laborer, or any other parties similarly situated.

An aspect of the present specification includes a method of reducing an effect of a first plant parasitic nematode population on a first plant and a seed in soil comprising applying to the first plant, soil, or seed a composition comprising an inoculant comprising Streptomyces lydicus, where the composition is capable of reducing the effect of the first population of plant parasitic nematode relative to a second plant parasitic nematode population where the composition was not applied to a second plant, soil, or seed.

In an aspect, the composition comprising an inoculant comprising Streptomyces lydicus does not comprise a chemical component comprising a 3,5-disubstituted-1,2,4-oxadiazole or a salt thereof. In an aspect, the composition comprising an inoculant comprising Streptomyces lydicus does not comprise an effective amount of a compound having Formula I, Ia, Ib, II, IIa, IIb, III, IIIa, IIIb, IV, IVa, IVb, V, Va, Vb, VI, VIa, VIb, VII, VIIa, or VIIb.

In another aspect, the present specification further provides growing or planting a corn plant or corn seed applied with the composition in a field which corn was grown during a growing season that immediately precedes planting of the corn plant or corn seed, where the composition is capable of reducing a corn-on-corn yield penalty. As used herein, the term “corn-on-corn” is intended to mean corn plantings in two or more consecutive growing seasons in the same fields and not rotated with a non-corn crop. The term “corn-on-corn yield penalty” (CCYP) is defined as follows:

CCYP=Y_{NC}−Y_{CC}

in which, Y_{NC} is the yield of corn in a later growing season following an immediate prior planting of a non-corn (NC) plant in an earlier growing season, where the non-corn may be a nitrogen-fixing plant, the nitrogen-fixing plant may or may not be a leguminous plant, and the leguminous plant may or may not be a soybean plant. In addition, the non-corn may be a non-nitrogen fixing plant, including but not limited to, wheat and cotton; and Y_{CC} is the yield of corn in a later growing season following an immediate prior planting of corn in an earlier growing season. As used herein, the term “growing season(s)” is intended to mean a period of time in a given year when the climate is prime for crops to experience the most growth.

In one aspect the reduction of a corn-on-corn yield penalty is more than 3%, 5%, 10%, 15% or 20% of an untreated corn seed or plant. In one aspect, a corn-on-corn yield penalty is measured on a single plant. In other aspects, a corn-on-corn yield penalty is measured on a group of plants where the group of plants is greater than 100, 200, 500, or 1000 corn plants. In one aspect, CCYP reduction is a capability of a provided composition or method.

In an aspect, the present specification includes a method comprising applying to a first corn plant, soil, or corn seed a composition comprising (a) a first inoculant comprising Streptomyces lydicus, and (b) a chemical component comprising a 3,5-disubstituted-1,2,4-oxadiazole or a salt thereof, where the composition is capable of reducing an effect of the first population of plant parasitic nematode for the first corn plant or corn seed in soil relative to a second corn plant or corn seed in soil in need of reducing the effect of a second corn plant parasitic nematode population where the composition was not applied and (c) a second inoculant comprising Penicillium bilaii to the first corn plant, soil, or corn seed, where the first corn plant, soil, or corn seed is grown in a field in which corn was grown during a growing season that immediately precedes planting of the population of corn plants or corn seeds, where the second inoculant is capable of reducing a corn-on-corn yield penalty.

As used herein, the term Penicillium bilaii is intended to include all iterations of the species name, such as “Penicillium bilaiae” and “Penicillium bilaji.”

In an aspect, the present specification includes a method comprising applying to a first corn plant, soil, or corn seed a composition comprising (a) a first inoculant comprising Streptomyces lydicus, where the composition is capable of reducing an effect of the first population of plant parasitic nematode for the first corn plant or corn seed in soil relative to a second corn plant or corn seed in soil in need of reducing the effect of a second corn plant parasitic nematode population where the composition was not applied and (b) a second inoculant comprising Penicillium bilaii to the first corn plant, soil, or corn seed, where the first corn plant, soil, or corn seed is grown in a field in which corn was grown during a growing season that immediately precedes planting of the population of corn plants or corn seeds, where the second inoculant is capable of reducing a corn-on-corn yield penalty.

In an aspect of the present specification any method set forth in the U.S. Provisional Application Nos. 62/258,118 and 62,258,124 filed Nov. 20, 2015 can be combined with any method set forth herein.

All publications are herein incorporated by reference to the same extent as if each individual publication or patent application were specifically and individually indicated to be incorporated by reference. Although the specification herein has been described with reference to particular aspects, it is to be understood that these aspects are merely illustrative of the principles and applications of the present specification. It is therefore to be understood that numerous modifications may be made to the illustrative aspects and that other arrangements may be devised without departing from the spirit and scope of the present specification as defined by the appended claims.

The following are exemplary embodiments of the present specification.

### Embodiment 1

A method of reducing an effect of a parasitic nematode population on a plant or seed in soil comprising applying to said plant, soil, or seed a composition comprising: (a) an inoculant comprising Streptomyces lydicus, and (b) a chemical component comprising a 3,5-disubstituted-1,2,4-oxadiazole or a salt thereof.

### Embodiment 2

The method of embodiment 1, wherein said composition is capable of reducing said effect of said parasitic nematode population on said plant or seed in soil relative to a plant or seed in soil wherein said composition was not applied.

### Embodiment 3

The method of embodiments 1 or 2, wherein said composition reduces said parasitic nematode population on said plant or seed in soil.

### Embodiment 4

The method of any one of embodiments 1 to 3, wherein said effect of said plant parasitic nematode population is reduced by at least 5, 10, 15, 20, 25, 30, 35, 40, 45, 50, 55, 60, 65, 70, 75, 80, 85, 90, 95, or 100% for said plant, soil, or seed.

### Embodiment 5

The method of any one of embodiments 1 to 4, wherein one or more characteristics selected from the group consisting of germination frequency, plant height, plant weight, days to maturity, and yield is enhanced by at least 1, 2, 3, 4, 5, 10, 15, 20, 25, 30, 35, 40, 45, 50, 55, 60, 65, 70, 75, 80, 85, 90, 95, 100, 125, 150, 175, 200, 250, 300%, or more for said plant or seed in soil.

### Embodiment 6

The method of any one of embodiments 1 to 5, wherein said

Streptomyces lydicus comprises Streptomyces lydicus strain WYEC 108.

### Embodiment 7

The method of embodiment 6, wherein said Streptomyces lydicus strain WYEC 108 comprises strain ATCC 55445 or derivatives thereof.

### Embodiment 8

The method of any one of embodiments 1 to 7, wherein said Streptomyces lydicus strain WYEC 108 comprises spores.

### Embodiment 9

The method of any one of embodiments 1 to 8, further comprising iron and humate.

### Embodiment 10

The method of embodiment 9, wherein the humate is selected from a group consisting of fulvic and humic acids.

### Embodiment 11

The method of any one of embodiments 1 to 10, wherein said inoculant comprises a delivery medium.

### Embodiment 12

The method of embodiment 11, wherein said delivery medium comprises an effective amount of a component selected from the group consisting of alginate gel, peat moss, sand, cornmeal, and a nitrogen source.

### Embodiment 13

The method of embodiment 12, wherein said nitrogen source is ammonium chloride.

### Embodiment 14

The method of any one of embodiments 1 to 13, wherein said chemical component comprises a compound of Formula IV or a salt thereof

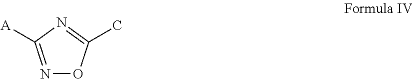

wherein
A is phenyl, pyrazyl, oxazolyl or isoxazolyl, each of which can be optionally independently substituted with one or more substituents selected from the group consisting of halogen, CF₃, CH₃, OCF₃, OCH₃, CN, and C(H)O; and
C is thienyl, furanyl, oxazolyl or isoxazolyl, each of which can be optionally independently substituted with one or more substituents selected from F, Cl, CH₃, and OCF₃.

### Embodiment 15

The method of embodiment 14, wherein said chemical component comprises a compound of Formula IVa or a salt thereof

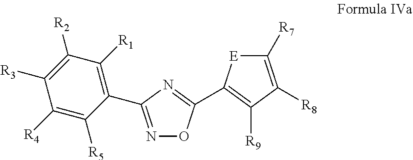

wherein
R₁ and R₅ are independently selected from hydrogen, CH₃, F, Cl, Br, CF₃ and OCF₃;
R₂ and R₄ are independently selected from hydrogen, F, Cl, Br, and CF₃;
R₃ is selected from hydrogen, CH₃, CF₃, F, Cl, Br, OCF₃, OCH₃, CN, and C(H)O;
R₇ and R₈ are independently selected from hydrogen and F;
R₉ is selected from hydrogen, F, Cl, CH₃, and OCF₃; and
E is O, N or S.

### Embodiment 16

The method of any one of embodiment 14, wherein said chemical component comprises a compound of Formula IVb or a salt thereof

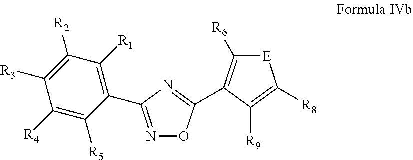

wherein
R₁ and R₅ are independently selected from hydrogen, CH₃, F, Cl, Br, CF₃ and OCF₃;
R₂ and R₄ are independently selected from hydrogen, F, Cl, Br, and CF₃;
R₃ is selected from hydrogen, CH₃, CF₃, F, Cl, Br, OCF₃, OCH₃, CN, and C(H)O;
R₈ is selected from hydrogen and fluorine;
R₆ and R₉ are independently selected from hydrogen, F, Cl, CH₃, and OCF₃; and
E is O or S.

### Embodiment 17

The method of any one of embodiments 1-13, wherein said chemical component comprises an effective amount of a compound selected from the group consisting of
3-phenyl-5-(thiophen-2-yl)-1,2,4-oxadiazole,
5-(furan-2-yl)-3-phenyl-1,2,4-oxadiazole,
3-(4-fluorophenyl)-5-(thiophen-2-yl)-1,2,4-oxadiazole,
3-(4-fluorophenyl)-5-(furan-2-yl)-1,2,4-oxadiazole,
3-(4-chlorophenyl)-5-(thiophen-2-yl)-1,2,4-oxadiazole,
3-(4-chlorophenyl)-5-(furan-2-yl)-1,2,4-oxadiazole,
3-(4-bromophenyl)-5-(thiophen-2-yl)-1,2,4-oxadiazole,
3-(4-bromophenyl)-5-(furan-2-yl)-1,2,4-oxadiazole,
3-(4-chloro-2-methylphenyl)-5-(furan-2-yl)-1,2,4-oxadiazole,
3-(2,4-dichlorophenyl)-5-(furan-2-yl)-1,2,4-oxadiazole,
5-(4-chloro-2-methylphenyl)-3-(furan-2-yl)-1,2,4-oxadiazole,
3-(4-chlorophenyl)-5-(thiophen-3-yl)-1,2,4-oxadiazole,
3-(4-chlorophenyl)-5-(furan-3-yl)-1,2,4-oxadiazole,
3-(4-fluorophenyl)-5-(thiophen-3-yl)-1,2,4-oxadiazole,
3-(4-fluorophenyl)-5-(furan-3-yl)-1,2,4-oxadiazole, and
2-(4-chlorophenyl)-5-(thiophen-2-yl)-1,3,4-oxadiazole.

### Embodiment 18

The method of any one of embodiment 1 to 13, wherein said chemical component comprises a compound of Formula V or a salt thereof

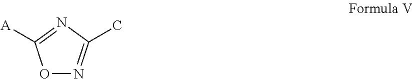

wherein,
A is phenyl, pyrazyl, oxazolyl or isoxazolyl each of which can be optionally independently substituted with one or more substituents selected from halogen, CF₃, CH₃, OCF₃, OCH₃, CN, and C(H)O; and
C is thienyl, furanyl, oxazolyl or isoxazolyl each of which can be optionally independently substituted with one or more substituents selected from fluorine, chlorine, CH₃, and OCF₃.

### Embodiment 19

The method of embodiment 18, wherein said chemical component comprises a compound of Formula Va or a salt thereof,

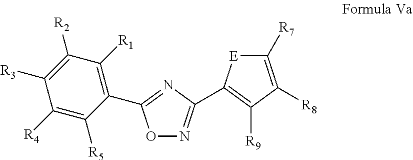

wherein,
R₁ and R₅ are independently selected from hydrogen, CH₃, F, Cl, Br, CF₃ and OCF₃;
R₂ and R₄ are independently selected from hydrogen, F, Cl, Br, and CF₃;
R₃ is selected from hydrogen, CH₃, CF₃, F, Cl, Br, OCF₃, OCH₃, CN, and C(H)O;
R₇ and R₈ are independently selected from hydrogen and fluorine;
R₉ is selected from hydrogen, F, Cl, CH₃, and OCF₃; and
E is O or S.

### Embodiment 20

The method of embodiment 18, wherein said chemical component comprises a compound of Formula Vb or a salt thereof,

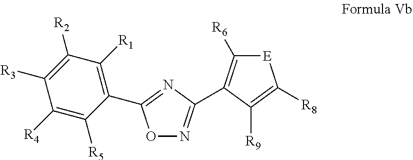

wherein,
R₁ and R₅ are independently selected from hydrogen, CH₃, F, Cl, Br, CF₃ and OCF₃;
R₂ and R₄ are independently selected from hydrogen, F, Cl, Br, and CF₃;
R₃ is selected from hydrogen, CH₃, CF₃, F, Cl, Br, OCF₃, OCH₃, CN, and C(H)O;
R₈ is selected from hydrogen and fluorine;
R₆ and R₉ are independently selected from hydrogen, F, Cl, CH₃, and OCF₃; and
E is O or S.

### Embodiment 21

The method of any one of embodiment 1 to 13, wherein said chemical component comprises a compound of Formula V or a salt thereof

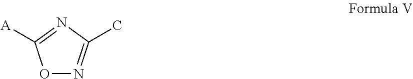

wherein,
A is phenyl, pyridyl, pyrazyl, oxazolyl or isoxazolyl each of which can be optionally independently substituted with one or more substituents selected from halogen, CF₃, CH₃, OCF₃, OCH₃, CN, and C(H)O; and
C is oxazolyl which can be optionally independently substituted with one or more substituents selected from fluorine, chlorine, CH₃, and OCF₃.

### Embodiment 22

The method of any one of embodiments 1 to 21, wherein said chemical component comprises 3-phenyl-5-(thiophen-2-yl)-1,2,4-oxadiazole.

### Embodiment 23

The method of any one of embodiments 1 to 22, wherein said composition comprises an agronomically acceptable carrier.

### Embodiment 24

The method of any one of embodiments 1 to 23, wherein said composition comprises a surfactant.

### Embodiment 25

The method of any one of embodiments 1 to 24, wherein said composition comprises an insecticide, a second nematicide, a fungicide, a herbicide, a pesticide, or a combination thereof.

### Embodiment 26

The method of embodiment 25, wherein said fungicide is selected from the group consisting of aromatic hydrocarbons, benzimidazoles, benzthiadiazoles, carboxamides, carboxylic acid amides, morpholines, phenylamides, phosphonates, quinone outside inhibitors, thiazolidines, thiophanates, thiophene carboxamides, and triazoles.

### Embodiment 27

The method of embodiment 26, wherein said quinone outside inhibitors are strobilurins.

### Embodiment 28

The method of embodiment 25, wherein said insecticide and said second nematicide are selected from the group consisting of carbamates, diamides, macrocyclic lactones, neonicotinoids, organophosphates, phenylpyrazoles, pyrethrins, spinosyns, synthetic pyrethroids, tetronic and tetramic acids.

### Embodiment 29

The method of embodiment 25, wherein said herbicide is selected from the group consisting of aryloxyphenoxypriopionates, cyclohexandiones, EPSPS inhibitors, glutamine synthetase inhibitors, synthetic auxins, photosystem II inhibitors, ALS (AHAS) inhibitors, photosystem I inhibitors, protoporphyrinogen oxidase (PPO) inhibitors, mitosis inhibitors, cellulose inhibitors, oxidative phosphorylation uncouplers, fatty acid and lipid biosynthesis inhibitors, auxin transport inhibitors, carotenoid biosynthesis inhibitors, cell division inhibitors, and 4-hydroxyphenylpyruvate dioxygenase inhibitors.

### Embodiment 30

The method of any one of embodiments 1 to 29, further comprising applying one or more compositions selected from the group consisting of one or more agronomically beneficial elements to said first soil, one or more agronomically beneficial elements to said first seed, one or more agronomically beneficial elements to said first plant that germinates from said first seed, one or more lipo-chitooligosaccharides, one or more chitooligosaccharides, one or more chitinous compounds, one or more isoflavonoids, jasmonic acid or derivatives thereof, linolenic acid or derivatives thereof, linoleic acid or derivatives thereof, one or more karrakins, one or more fertilizers, and any combination of the above compositions.

### Embodiment 31

The method of any one of embodiments 1 to 30, wherein said plant is selected from the group consisting of corn, soybean, cotton, wheat, canola, cucurbits vegetables, fruiting vegetables, leafy vegetables, tobacco plants, banana plants, and turf grasses.

### Embodiment 32

The method of any one of embodiments 1 to 31, wherein said plant is a corn plant.

### Embodiment 33

The method of any one of embodiments 1 to 31, wherein said seed is a corn seed.

### Embodiment 34

The method of any one of embodiments 1 to 31, wherein said plant is a soybean plant.

### Embodiment 35

The method of any one of embodiments 1 to 31, wherein said seed is a soy seed.

### Embodiment 36

The method of any one of embodiments 1 to 31, wherein said plant is a cotton plant.

### Embodiment 37

The method of any one of embodiments 1 to 31, wherein said seed is a cotton seed.

### Embodiment 38

The method of any one of embodiments 1 to 37, wherein said plant parasitic nematode is selected from the group of consisting of microorganisms from the genera Pratylenchus, Heterodera, Globodera, Meloidogyne, Rotylenchulus, Hoplolaimus, Belonolaimus, Longidorus, Paratrichodorus, Ditylenchus, Xiphinema, Helicotylenchus, Radopholus, Hirschmanniella, Tylenchorhynchus, and Trichodorus.

### Embodiment 39

The method of any one of embodiments 1 to 38, wherein said plant parasitic nematode is from the genus Meloidogyne.

### Embodiment 40

The method of embodiment 39, wherein said plant parasitic nematode is Meloidogyne incognita.

### Embodiment 41

The method of any one of embodiments 1 to 38, wherein said plant parasitic nematode is from the genus Heterodera.

### Embodiment 42

The method of embodiment 41, wherein said plant parasitic nematode is Heterodera glycines.

### Embodiment 43

The method of any one of embodiments 1 to 42, wherein said chemical component is present in a concentration from about 10⁻² to 10⁻¹⁰ Molar.

### Embodiment 44

The method of any one of embodimenst 1 to 42, wherein said composition is present in an amount from 10⁻⁹ to 1 μg/seed.

### Embodiment 45

The method of any one of embodiments 1 to 42, wherein said composition is present in an amount from 1 g/container to 1 kg/container.

### Embodiment 46

The method of any one of embodiments 1 to 42, wherein said composition is provided in an amount from 8 to 16 ounce/acre.

### Embodiment 47

The method of any one of embodiments 1 to 46, wherein said inoculant is applied at a rate of 1×10², 5×10², 1×10³, 5×10³, 1×10⁴, 5×10⁴, 1×10⁵, 5×10⁵, 1×10⁶, 5×10⁶, 1×10⁷, 5×10⁷, or 1×10⁸ colony forming units per seed.

### Embodiment 48

The method of any one of embodiments 1 to 46, wherein said inoculant is applied at a rate of 1×10⁷, 5×10⁷, 1×10⁸, 5×10⁸, 1×10⁹, 5×10⁹, or 1×10¹⁰ spores per acre.

### Embodiment 49

The method of any one of embodiments 1 to 48, wherein said applying said composition is selected from the group consisting of coating said first seed with said composition prior to planting, applying said composition to said first soil prior to planting, applying said composition to said first soil at planting, applying said composition to said first soil after planting, and applying said composition to the foliage of said first plant.

### Embodiment 50

The method of embodiment 49, wherein said applying said composition further comprises pellet application, drench application, drip application, and any combinations thereof.

### Embodiment 51

The method of any one of embodiments 1 to 50, wherein said composition is in a form selected from the group consisting of a wettable powder, a granular powder, a liquid, a peat-based composition, and a seed coating.

### Embodiment 52

The method of any one of embodiments 1 to 51, further comprising providing a person with said seed and said composition.

### Embodiment 53

The method of any one of embodiments 1 to 51, further comprising providing a person with said composition.

### Embodiment 54

The method of any one of embodiments 1 to 53, further comprising growing said plant from said seed in said soil with said composition.

### Embodiment 55

The method of any one of embodiments 1 to 54, further comprising treating said seed with said composition and providing said treated seed to a farmer for growing in a field.

### Embodiment 56

The method of any one of embodiments 1 to 55, further comprising planting said seed in the soil.

### Embodiment 57

The method of any one of embodiments 1 to 56, further comprising immersing said seed in said composition and planting said seed in a field.

### Embodiment 58

The method of any one of embodiments 1 to 57, wherein said reduction of said effect of said plant parasitic nematode population on said plant or seed in soil by said composition is greater than a reduction of an effect of a plant parasitic nematode population by said inoculant alone at the same colony forming unit as used in said composition on a plant or seed in soil.

### Embodiment 59

The method of any one of embodiments 1 to 57, wherein said reduction of said effect of said plant parasitic nematode population on said plant or seed in soil by said composition is greater than a reduction of an effect of a plant parasitic nematode population by said chemical component alone at the same concentration as used in said composition on a plant or seed in soil.

### Embodiment 60

A method comprising providing to a person a first container of seeds and a composition comprising: (a) an inoculant comprising Streptomyces lydicus, and (b) a chemical component comprising a 3,5-disubstituted-1,2,4-oxadiazole or a salt thereof, wherein said composition is capable of reducing a first population of plant parasitic nematode for a first population of plants germinating from said first container of seeds relative to a second population of plant parasitic nematode for a second population of plants grown in a comparable field from a second container of seeds wherein said composition was not provided.

### Embodiment 61

The method of embodiment 60, wherein said composition is applied to said first container of seeds prior to said providing.

### Embodiment 62

The method of embodiment 60, wherein said composition is applied to said first container of seeds prior to planting.

### Embodiment 63

The method of embodiment 60, wherein said composition is applied to the soil prior to planting said first container of seeds.

### Embodiment 64

The method of embodiment 60, wherein said composition is applied to said first container of seeds at planting.

### Embodiment 65

The method of embodiment 60, wherein said composition is applied to the soil prior to development stage V1.

### Embodiment 66

The method of embodiment 60, wherein said composition is applied to the foliage of said first population of plants germinating from said first container of seeds.

### Embodiment 67

The method of any one of embodiments 60 to 66, wherein said composition is applied to the soil in pellet application.

### Embodiment 68

The method of any one of embodiments 60 to 66, wherein said composition is applied to the soil in drench application.

### Embodiment 69

The method of any one of embodiments 60 to 66, wherein said composition is applied to the soil in drip application.

### Embodiment 70

A method of reducing a first plant parasitic nematode population for a first plant, soil, or a seed comprising growing said first plant from said first seed in said first soil with a composition comprising: (a) an inoculant comprising Streptomyces lydicus, and (b) a chemical component comprising a 3,5-disubstituted-1,2,4-oxadiazole or a salt thereof, wherein said composition is capable of reducing said first plant parasitic nematode population for said first plant, soil, or seed relative to a second plant, soil, or seed in need of reducing a second plant parasitic nematode population without said composition.

### Embodiment 71

The method of embodiment 70, wherein said composition is applied to said first plant, soil, or seed.

### Embodiment 72

The method of embodiment 71, wherein said applied with said composition is selected from the group consisting of coating said first seed with said composition prior to planting, applying said composition to said first soil prior to planting, applying said composition to said first soil at planting, applying said composition to said first soil after planting, and applying said composition to the foliage of said first plant.

### Embodiment 73

The method of embodiment 72, wherein said applied with said composition further comprises pellet application, drench application, drip application, or any combinations thereof.

### Embodiment 74

The method of any one of embodiments 70 to 73, wherein said composition was applied to said first soil in-furrow.

### Embodiment 75

The method of any one of embodiments 70 to 74, wherein said first population of plant parasitic nematode is reduced by at least 5, 10, 15, 20, 25, 30, 35, 40, 45, 50, 55, 60, 65, 70, 75, 80, 85, 90, 95, 100% in said first plant or soil relative to said second plant or soil wherein said composition was not applied.

### Embodiment 76

A method comprising growing a first population of plants from a first container of seeds, wherein said seeds are planted in soil with a composition comprising an inoculant comprising Streptomyces lydicus and a chemical component comprising a 3,5-disubstituted-1,2,4-oxadiazole or a salt thereof, wherein said composition is capable of increasing a yield of said first population of plants relative to a second population of plants, soil, or a second container of seeds grown in a comparable field without said composition.

### Embodiment 77

The method of embodiment 76, wherein said yield from said first population of plants is enhanced by at least 5, 10, 15, 20, 25, 30, 35, 40, 45, 50, 55, 60, 65, 70, 75, 80, 85, 90, 95, 100, 125, 150, 175, 200, 250, 300%, or more relative to a yield from said second population of plants.

### Embodiment 78

The method of embodiment 76, wherein one or more characteristics of plant growth for said first population of plants selected from the group consisting of plant height, plant weight, and days to maturity is enhanced by at least 1, 2, 3, 4, 5, 10, 15, 20, 25, 30, 35, 40, 45, 50, 55, 60, 65, 70, 75, 80, 85, 90, 95, 100, 125, 150, 175, 200, 250, 300%, or more relative to said second population of plants.

### Embodiment 79

The method of embodiment 76, wherein said first or second population of plants is selected from the group consisting of corn plants and soybean plants.

### Embodiment 80

The method of any one of embodiments 76 to 79, wherein said composition is applied to seeds in said first container of seeds.

### Embodiment 81

The method of any one of embodiments 76 to 79, wherein said composition is applied to the soil prior to planting of seeds from said first container of seeds.

### Embodiment 82

The method of any one of embodiments 76 to 79, wherein said composition is applied to the soil at planting of seeds from said first container of seeds.

### Embodiment 83

The method of any one of embodiments 76 to 79, wherein said composition is applied to the soil after planting of seeds from said first container of seeds.

### Embodiment 84

The method of any one of embodiments 76 to 79, wherein said composition is applied to the foliage of said first population of plants.

### Embodiment 85

The method of any one of embodiments 76 to 84, wherein said composition is applied the soil using pellet application.

### Embodiment 86

The method of any one of embodiments 76 to 84, wherein said composition is applied to the soil using drench application.

### Embodiment 87

The method of any one of embodiments 76 to 84, wherein said composition is applied the soil using drip application.

### Embodiment 88

A method comprising: (a) treating a first container of seeds with a composition comprising an inoculant comprising Streptomyces lydicus and a chemical component comprising a 3,5-disubstituted-1,2,4-oxadiazole or a salt thereof, and (b) providing said treated first container of seeds to a farmer for growing in a field, wherein said composition is capable of reducing a first plant parasitic nematode population for a first population of plants germinating from said first container of seeds relative to a second plant parasitic nematode population for a second population of plants in a comparable field germinating from a second container of seeds wherein said composition was not applied.

### Embodiment 89

The method of embodiment 88, wherein said treating with said composition is prior to said providing.

### Embodiment 90

The method of embodiment 88, wherein said treating with said composition is prior to planting of seeds from said first container of seeds.

### Embodiment 91

The method of embodiment 88, wherein said treating is applying said composition to said first container of seeds as a seed coating.

### Embodiment 92

A method of reducing a first plant parasitic nematode population for a first plant, soil, or a seed comprising: (a) planting said first seed in said first soil; and (b) applying a composition comprising an inoculant comprising Streptomyces lydicus and a chemical component comprising a 3,5-disubstituted-1,2,4-oxadiazole or a salt thereof to said first plant germinating from said first seed or to said first soil, wherein said composition is capable of reducing said first population of plant parasitic nematode in said first plant, soil, or seed relative to a second plant, soil, or seed in need of reducing a second plant parasitic nematode population wherein said composition was not applied.

### Embodiment 93

The method of embodiment 92, wherein said applying said composition is selected from the group consisting of applying said composition to said first seed prior to planting, applying said composition to said first soil prior to planting, applying said composition to said first soil at planting, applying said composition to said first soil after planting, and applying said composition to the foliage of said first plant germinating from said first seed.

### Embodiment 94

The method of embodiment 93, wherein said applying said composition further comprises pellet application, drench application, drip application, or any combinations thereof.

### Embodiment 95

The method of any one of embodiments 92 to 94, wherein said first plant parasitic nematode population is reduced by at least 5, 10, 15, 20, 25, 30, 35, 40, 45, 50, 55, 60, 65, 70, 75, 80, 85, 90, 95, 100% for said first plant, soil, or seed in relative to said second plant, soil, or seed.

### Embodiment 96

A method of protecting against nematode infection for a first plant, soil, or a seed, said method comprising: (a) providing a composition comprising an inoculant comprising Streptomyces lydicus and a chemical component comprising a 3,5-disubstituted-1,2,4-oxadiazole or a salt thereof, and (b) applying said composition to said first plant, soil, or seed wherein said composition is capable of protecting said first plant against plant parasitic nematode infection relative to a second plant, soil, or seed in need of protecting against nematode infection wherein said composition was not applied.

### Embodiment 97

The method of embodiment 96, wherein said applying said composition is selected from the group consisting of applying said composition to said first seed prior to planting, applying said composition to said first soil prior to planting, applying said composition to said first soil at planting, applying said composition to said first soil after planting, and applying said composition to the foliage of said first plant germinating from said first seed.

### Embodiment 98

The method of embodiment 97, wherein said applying said composition further comprises pellet application, drench application, drip application, or any combinations thereof.

### Embodiment 99

A method for reducing the susceptibility to nematode infections or enhancing the germination frequency for a first seed, said method comprises: (a) immersing said first seed in a composition comprising an inoculant comprising Streptomyces lydicus and a chemical component comprising a 3,5-disubstituted-1,2,4-oxadiazole or a salt thereof, and (b) planting said first seed in a field, wherein said composition is capable of reducing the susceptibility to nematode infections or enhancing the germination frequency of said first seed relative to a second seed in need of reducing the susceptibility to nematode infections or enhancing the germination frequency wherein said composition was not immersed.

### Embodiment 100

The method of embodiment 99, wherein said immersing is prior to said planting of said first seed.

### Embodiment 101

The method of embodiments 99 or 100, wherein a first population of plant parasitic nematode for a first plant germinating from said first seed is reduced by at least 5, 10, 15, 20, 25, 30, 35, 40, 45, 50, 55, 60, 65, 70, 75, 80, 85, 90, 95, 100% relative to a second population of plant parasitic nematode for a second plant germinating from said second seed.

### Embodiment 102

A method of reducing an effect of a first plant parasitic nematode population on a first plant and a seed in soil comprising applying to said first plant, soil, or seed a composition comprising an inoculant comprising Streptomyces lydicus, wherein said composition is capable of reducing said effect of said first population of plant parasitic nematode relative to a second plant parasitic nematode population wherein said composition was not applied to a second plant, soil, or seed.

### Embodiment 103

The method of embodiment 102, wherein said first plant parasitic nematode population is reduced by at least 5, 10, 15, 20, 25, 30, 35, 40, 45, 50, 55, 60, 65, 70, 75, 80, 85, 90, 95, or 100% for said first plant, soil, or seed relative to said second plant parasitic nematode population wherein said composition was not applied to said second plant, soil, or seed.

### Embodiment 104

The method of embodiment 102, wherein one or more characteristics selected from the group consisting of germination frequency, plant height, plant weight, days to maturity, and yield is enhanced by at least 1, 2, 3, 4, 5, 10, 15, 20, 25, 30, 35, 40, 45, 50, 55, 60, 65, 70, 75, 80, 85, 90, 95, 100, 125, 150, 175, 200, 250, 300%, or more for said first plant, soil, or seed relative to said second plant, soil, or seed.

### Embodiment 105

The method of any one of embodiments 102 to 104, wherein said Streptomyces lydicus comprises Streptomyces lydicus strain WYEC 108.

### Embodiment 106

The method of embodiment 105, wherein said Streptomyces lydicus strain WYEC 108 comprises strain ATCC 55445 or derivatives thereof.

### Embodiment 107

The method of embodiment 106, wherein said Streptomyces lydicus strain WYEC 108 comprises spores.

### Embodiment 108

The method of any one of embodiments 102 to 107, wherein said composition comprises a delivery medium.

### Embodiment 109

The method of embodiment 108, wherein said delivery medium comprises an effective amount of a component selected from the group consisting of alginate gel, peat moss, sand, cornmeal, and a nitrogen source.

### Embodiment 110

The method of embodiment 109, wherein said nitrogen source is ammonium chloride.

### Embodiment 111

The method of any one of embodiments 102 to 110, wherein said composition does not comprise a chemical component comprising a 3,5-disubstituted-1,2,4-oxadiazole or a salt thereof.

### Embodiment 112

The method of any one of embodiments 102 to 111, wherein said composition is in a form selected from the group consisting of a wettable powder, a granular powder, a liquid, a peat-based composition, and a seed coating.

### Embodiment 113

The method of any one of embodiments 102 to 112, wherein said applying said composition is selected from the group consisting of coating said first seed with said composition prior to planting, applying said composition to said first soil prior to planting, applying said composition to said first soil at planting, applying said composition to said first soil after planting, and applying said composition to the foliage of said first plant.

### Embodiment 114

The method of embodiment 113, wherein said applying said composition further comprises pellet application, drench application, drip application, or any combinations thereof.

### Embodiment 115

The method of any one of embodiments 102 to 114, wherein said first or second plant is selected from the group consisting of corn, soybean, cotton, wheat, canola, cucurbits vegetables, fruiting vegetables, leafy vegetables, tobacco plants, banana plants, and turf grasses.

### Embodiment 116

The method of any one of embodiments 102 to 114, wherein said first or second plant is a corn plant.

### Embodiment 117

The method of any one of embodiments 102 to 114, wherein said first or second plant is a soybean plant.

### Embodiment 118

The method of any one of embodiments 102 to 117, wherein said first or second plant parasitic nematode is selected from the group consisting of Pratylenchus, Heterodera, Globodera, Meloidogyne, Rotylenchulus, Hoplolaimus, Belonolaimus, Longidorus, Paratrichodorus, Ditylenchus, Xiphinema, Helicotylenchus, Radopholus, Hirschmanniella, Tylenchorhynchus, and Trichodorus.

### Embodiment 119

The method of embodiment 118, wherein said first or second plant parasitic nematode is Meloidogyne incognita.

### Embodiment 120

The method of embodiment 118, wherein said first or second plant parasitic nematode is Heterodera glycines.

### Embodiment 121

A plant parasitic nematicidal composition comprising: (a) an inoculant comprising Streptomyces lydicus, and (b) a chemical component comprising a 3,5-disubstituted-1,2,4-oxadiazole or a salt thereof, wherein said composition is capable of reducing an effect of a first plant parasitic nematode population on a first plant or seed in soil relative to a second plant or seed in soil in need of reducing said effect of a second plant parasitic nematode population wherein said composition was not applied.

### Embodiment 122

The composition of embodiment 121, wherein said reduction of said effect of said first plant parasitic nematode population on said first plant or seed in soil by said composition is greater than a reduction of said effect of a third plant parasitic nematode population by said inoculant alone at the same colony forming unit as used in said composition on a third plant or seed in soil in need of reducing an effect of a third plant parasitic nematode population.

### Embodiment 123

The composition of embodiment 121, wherein said reduction of said effect of said first plant parasitic nematode population on said first plant or seed in soil by said composition is greater than a reduction of said effect of a fourth plant parasitic nematode population by said chemical component alone at the same concentration as used in said composition on a fourth plant or seed in soil in need of reducing an effect of a fourth plant parasitic nematode population.

### Embodiment 124

The composition of any one of embodiments 121 to 123, wherein said first plant parasitic nematode population is reduced by at least 5, 10, 15, 20, 25, 30, 35, 40, 45, 50, 55, 60, 65, 70, 75, 80, 85, 90, 95, or 100% for said first plant, soil, or seed relative to said second plant parasitic nematode population wherein said composition was not applied to said second plant, soil, or seed.

### Embodiment 125

The composition of any one of embodiments 121 to 123, wherein one or more characteristics selected from the group consisting of germination frequency, plant height, plant weight, days to maturity, and yield is enhanced by at least 1, 2, 3, 4, 5, 10, 15, 20, 25, 30, 35, 40, 45, 50, 55, 60, 65, 70, 75, 80, 85, 90, 95, 100, 125, 150, 175, 200, 250, 300%, or more for said first plant, soil, or seed relative to said second plant, soil, or seed.

### Embodiment 126

The composition of any one of embodiments 121 to 125, wherein said Streptomyces lydicus comprises Streptomyces lydicus strain WYEC 108.

### Embodiment 127

The composition of any one of embodiments 121 to 126, wherein said chemical component comprises 3-phenyl-5-(2-thienyl)-1,2,4-oxadiazole.

### Embodiment 128

The composition of any one of embodiments 121 to 127, wherein said first or second plant parasitic nematode is from the genus Meloidogyne.

### Embodiment 129

The composition of embodiment 128, wherein said first or second plant parasitic nematode is Meloidogyne incognita.

### Embodiment 130

The composition of any one of embodiments 121 to 127, wherein said first or second plant parasitic nematode is from the genus Heterodera.

### Embodiment 131

The composition of embodiment 130, wherein said first or second plant parasitic nematode is Heterodera glycines.

### Embodiment 132

A method comprising applying to a first corn plant, soil, or corn seed a composition comprising (a) a first inoculant comprising Streptomyces lydicus, and (b) a chemical component comprising a 3,5 disubstituted 1,2,4 oxadiazole or a salt thereof, wherein said composition is capable of reducing an effect of said first population of plant parasitic nematode for said first corn plant or corn seed in soil relative to a second corn plant or corn seed in soil in need of reducing said effect of a second corn plant parasitic nematode population wherein said composition was not applied and (c) a second inoculant comprising Penicillium bilaii to said first corn plant, soil, or corn seed, wherein said first corn plant, soil, or corn seed is grown in a field in which corn was grown during a growing season that immediately precedes planting of said population of corn plants or corn seeds, wherein said inoculant is capable of reducing a corn on corn yield penalty.

### Embodiment 133

The method of embodiment 132, wherein said first and second inoculants are provided as a single inoculant.

### Embodiment 134

The method of embodiment 132, wherein said first and second inoculants are provided as two inoculants.

### Embodiment 135

A method comprising applying to a first corn plant, soil, or corn seed a composition comprising (a) a first inoculant comprising Streptomyces lydicus, wherein said composition is capable of reducing an effect of said first population of plant parasitic nematode for said first corn plant or corn seed in soil relative to a second corn plant or corn seed in soil in need of reducing said effect of a second corn plant parasitic nematode population wherein said composition was not applied and (b) a second inoculant comprising Penicillium bilaii to said first corn plant, soil, or corn seed, wherein said first corn plant, soil, or corn seed is grown in a field in which corn was grown during a growing season that immediately precedes planting of said population of corn plants or corn seeds, wherein said inoculant is capable of reducing said corn on corn yield penalty.

### Embodiment 136

The method of embodiment 135, wherein said first and second inoculants are provided as a single inoculant.

### Embodiment 137

The method of embodiment 135, wherein said first and second inoculants are provided as two inoculants.

### EXAMPLES

### Example 1

### Isolation of Streptomyces WYEC 108

Streptomyces lydicus strain WYEC 108 is provided as Streptomyces species on the basis of the morphological characteristics of the genus Streptomyces, as defined by Bergey's Manual of Systematic Bacteriology (1986). Strain WYEC 108 is a filamentous bacterium that produces chains of spores in an aerial mycelium. Streptomyces WYEC 108 is isolated as one of a number of actinomycete strains isolated from soil taken from eight different sites in Great Britain. Along with other actinomycetes, Streptomyces WYEC 108 is isolated by the serial-dilution/spread-plate technique from rhizosphere soil associated with the roots of linseed plants in a field on Hastings Hill, South Downs, West Sussex, England. Various physiological characteristics of strain WYEC 108 are also determined: strain WYEC 108 does not produce melanin or H₂S on Peptone-Yeast-Iron Agar and Peptone-Iron Agar (Difco Lab. Detroit, Mich.), respectively. The color of the spore mass produced by Streptomyces WYEC 108 on CYD plates is gray. This strain does not grow at 45° C. Streptomyces WYEC 108 is characterized as belonging to the species Streptomyces lydicus as defined by Bergey's Manual of Determinative Bacteriology (1986). Strain WYEC 108 colonizes plant roots in the presence of competition from rhizospere microflora. Strain WYEC 108 is shown to reduce a population of plant parasitic nematode and enhance the growth of corn and soybean plants growing in an agricultural field.

### Example 2

### Tioxazafen+ACTINOVATE® Provides a Significant Decrease in Nematode Population in Corn and Soybean Plants

Containers filled with soil collected from local field environments were placed in the ground in a randomized complete block design, 10 replications per treatment. Three corn or soybean seeds were treated before being planted to a depth of 1 inch in each microplot. The control group of corn or soybean seeds was treated with the base fungicide and insecticide only. The tested group of corn or soybean seeds was treated with 3-phenyl-5-(thiophen-2-yl)-1,2,4-oxadiazole (Tioxazafen), ACTINOVATE® STP or ACTINOVATE® AG comprising Streptomyces lydicus WYEC 108, or both. All treatments included a base fungicide and insecticide. The following table summarizes the treatments in the control and treatment groups:

TABLE 1
Treatment for corn and soybean seeds

| Group | Treatment for corn seeds | Treatment for soybean seeds |
|---|---|---|
| 1 | Base fungicide and insecticide | Base fungicide and insecticide |
| | only | only |
| 2 | Tioxazafen | Tioxazafen |
| 3 | ACTINOVATE ® STP | ACTINOVATE ® STP |
| 4 | Tioxazafen + | Tioxazafen + |
| | ACTINOVATE ® STP | ACTINOVATE ® STP |
| 5 | ACTINOVATE ® AG | ACTINOVATE ® AG |
| 6 | Tioxazafen + | Tioxazafen + |
| | ACTINOVATE ® AG | ACTINOVATE ® AG |

Each microplot was inoculated after planting by injecting root knot nematode (Meloidogyne incognita) eggs for the corn seeds or soybean cyst nematode (Heterodera glycines) eggs for the soybean seeds and mixing into the top 20 cm of soil to achieve an initial rate of 5,000 eggs/500 cc soil. Early season evaluations consisted of plant emergence, and plant height at 9 to 70 days after planting. Treatment efficacy was determined by extracting eggs and larvae from soil or from roots at harvest 60 to 70 days after planting. Results are expressed as total nematodes (eggs+J2 juveniles) per 500 cc of soil.

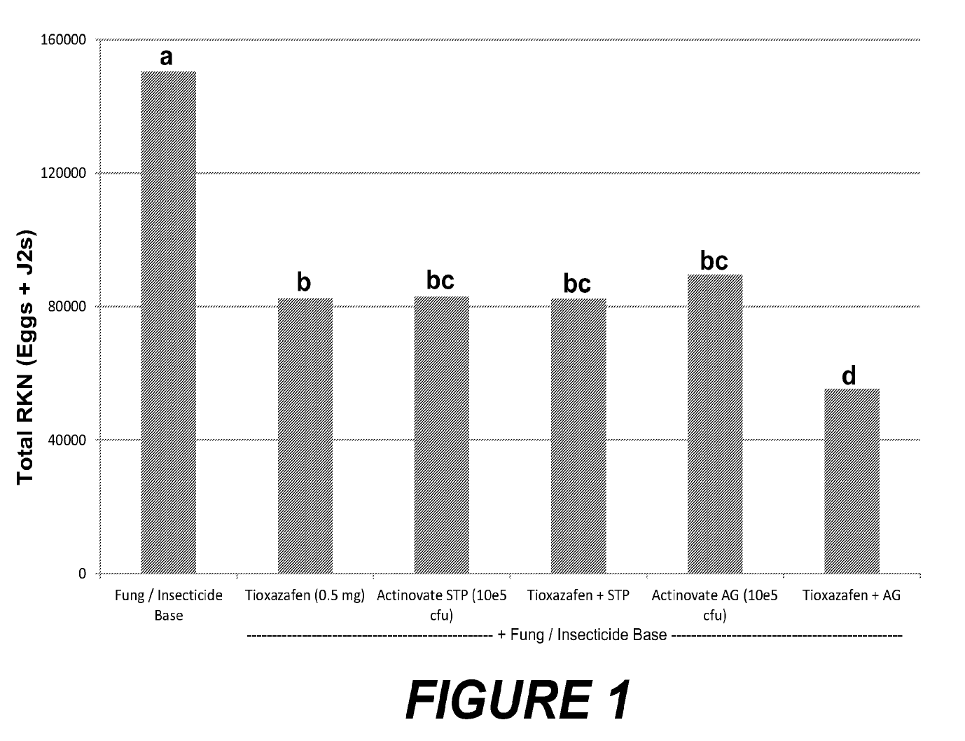

As shown in FIG. 1, the most efficacious treatment for corn seeds was the combination of Tioxazafen and ACTINOVATE® AG, providing a statistically significant reduction of root knot nematode (Meloidogyne incognita) compared to either product alone.

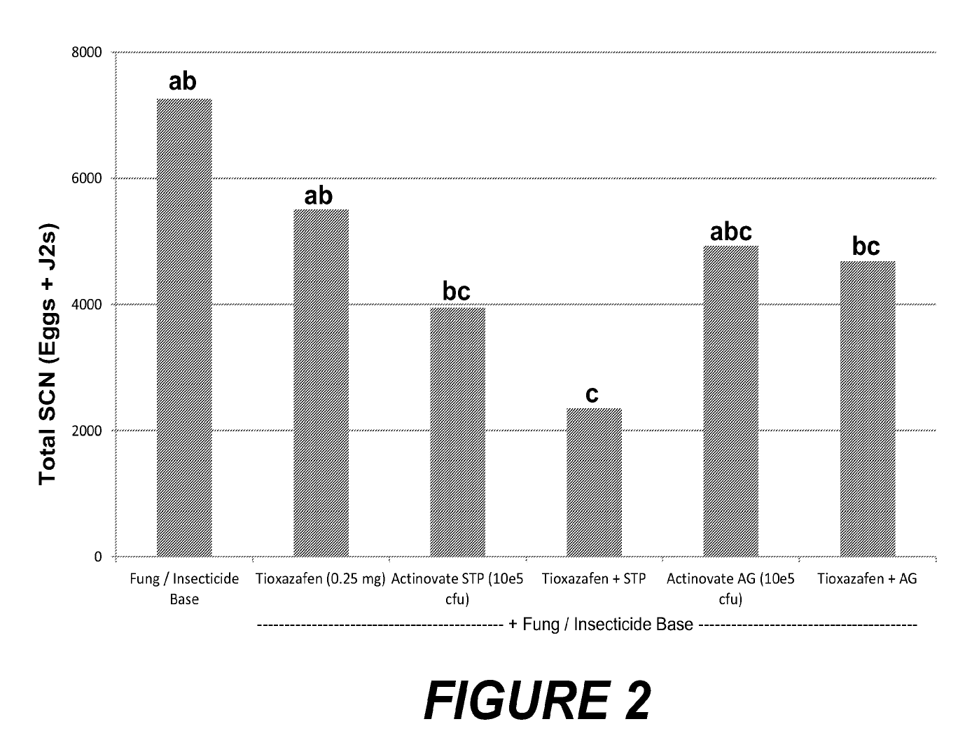

As shown in FIG. 2, the most efficacious treatment for soybean seeds was the combination of Tioxazafen and ACTINOVATE® STP, providing a statistically significant reduction of soybean cyst nematode (Heterodera glycines) compared to either product alone.

Therefore, the results show that the reduction of nematode population in corn or soybean plants when applied with Tioxazafen and ACTINOVATE® is greater than the reduction of nematode population in corn or soybean plants when applied with Tioxazafen or ACTINOVATE® alone.

### Example 3

ACTINOVATE® provides a decrease in nematode population in tomato plants through a bio-priming process.

Tomato seedlings were raised in cell plug trays which were subsequently transplanted into pots arranged in a randomized complete block design, 10 replications per treatment. Tomato seeds were treated before being planted in one inch square cell plug trays, each containing 192 cells. Included in the experiment was a negative control group of tomato seeds which were untreated (‘bare seed’) as well as a positive control based on the use of a chemical nematicide. The tested group of tomato seeds was treated with ACTINOVATE® STP comprising Streptomyces lydicus WYEC 108 based upon the process of bio-priming. In addition, ACTINOVATE® STP was applied to the transplant plug (14 days prior to transplanting) or in the transplanting process as a soil drench. The following table summarizes the treatments in the control and treatment groups:

| Treatment | Product | Method of Application |
|---|---|---|
| 1 | None - untreated control | NA |
| 2 | ACTINOVATE ® STP | Bioprimed seed |
| 3 | ACTINOVATE ® STP + | Bioprimed seed + |
| | ACTINOVATE ® STP | Soil drench to seedling |
| 4 | ACTINOVATE ® STP | Soil drench to seedling |
| 5 | Commercial chemical | Soil drench at transplant |
| | nematicide | |
| 6 | ACTINOVATE ® STP + | Bio-primed seed + |
| | ACTINOVATE ® STP + | Soil drench to seedling + |
| | ACTINOVATE ® STP | Soil drench at transplant |

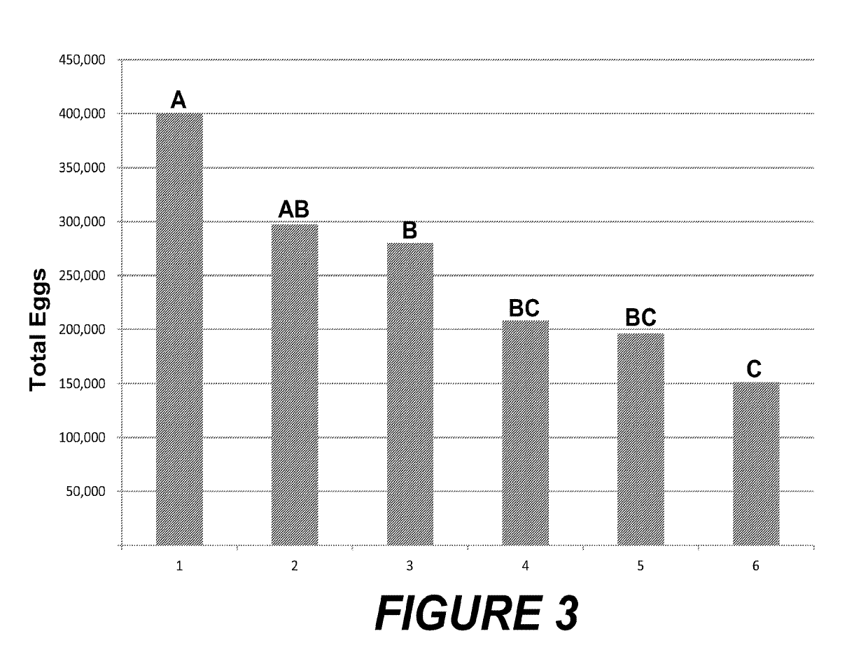

Each pot was inoculated prior to transplanting by drenching of 5 ml of root knot nematode inoculum containing a target rate of 4,000 eggs/ml onto the top of the soil and thoroughly mixing. Plants were allowed to grow for a period of five or more weeks after inoculation. Plants were harvested and evaluations recorded including above-ground dry plant biomass and below-ground fresh root biomass. Treatment efficacy was determined by extracting eggs and larvae from soil or from roots at harvest. Results are shown in FIG. 3. Results are expressed as total nematode eggs per gram of fresh weight root mass.

### Example 4: Wheat Microplot Assays

### Tioxazafen+ACTINOVATE® Provides a Significant Decrease in Nematode Population in Wheat Plants.

Wheat seeds are treated before being planted to a depth of 1 inch in each microplot. The control group is untreated seeds. The tested group of wheat seeds is treated with 3-phenyl-5-(thiophen-2-yl)-1,2,4-oxadiazole (Tioxazafen), ACTINOVATE® STP or ACTINOVATE® AG comprising Streptomyces lydicus WYEC 108, or both. The following table summarizes the treatments in the control and treatment groups:

| Group | Treatment for wheat seeds |
|---|---|
| 1 | No seed treatment |
| 2 | Tioxazafen |
| 3 | ACTINOVATE ® STP |
| 4 | Tioxazafen + ACTINOVATE ® STP |
| 5 | ACTINOVATE ® AG |
| 6 | Tioxazafen + ACTINOVATE ® AG |

Each microplot is inoculated after planting by infesting with cereal cyst nematode (Heterodera avenae) or lesion nematodes (Pratylenchus thornei, P. neglectus, or other Pratylenchus species). Early season evaluations consist of plant emergence, biomass and plant height throughout the season. Treatment efficacy is determined by extracting nematodes (juveniles, eggs, or cysts) from soil or from roots at or before harvest. Results are expressed as total nematodes (juveniles, eggs, or cysts) per 500 cc of soil.

### Example 5

### Tioxazafen+ACTINOVATE® in Wheat Plants

Wheat seeds are treated before planting. The control group is untreated seeds. The tested group of wheat seeds is treated with 3-phenyl-5-(thiophen-2-yl)-1,2,4-oxadiazole (Tioxazafen), ACTINOVATE® STP or ACTINOVATE® AG comprising Streptomyces lydicus WYEC 108, or both. The following table summarizes the treatments in the control and treatment groups:

| Group | Treatment for wheat seeds |
|---|---|
| 1 | No seed treatment |
| 2 and 3 | Tioxazafen (0.5 and 1 mg) |
| 4 | ACTINOVATE ® STP |
| 5 and 6 | Tioxazafen (0.5 and 1 mg) + |
| | ACTINOVATE ® STP |
| 7 | ACTINOVATE ® AG |
| 8 and 9 | Tioxazafen (0.5 and 1 mg) + |
| | ACTINOVATE ® AG |

Wheat is grown in a sand/turfuss mix. Seven (7) day old seedlings (9 reps) are inoculated with corn roots infested with corn lesion nematodes (Pratylenchus species). Seven (7) days after inoculation, corn roots are removed, seven (7) days later (14 dpi) wheat roots are removed from the pot, weighed for fresh weight and misted for seven (7) days to collect nematodes inside the roots. Treatment efficacy is determined by extracting nematodes (juveniles, eggs, or cysts) from soil or from roots at or before harvest. The collected nematodes are counted using a compound microscope. Results are expressed as total nematodes (juveniles, eggs, or cysts) per 500 cc of soil.

### Deposit of Biological Material

Applicant has made a deposit of a Streptomyces lydicus strain disclosed herein with the American Type Culture Collection (ATCC), Rockville, Md., USA. The deposit accession number for the Streptomyces lydicus strain is ATCC 55445, and the date of deposit was Jun. 29, 1993. Access to the deposits will be available during the pendency of the application to the Commissioner of Patents and Trademarks and persons determined by the Commissioner to be entitled thereto upon request. The deposits will be maintained for a period of 30 years, or 5 years after the most recent request, or for the enforceable life of the patent, whichever is longer, and will be replaced if they become nonviable during that period. Applicant does not waive any infringement of rights granted under this patent.

1. A method of reducing an effect of a parasitic nematode population on a plant or seed in soil comprising applying to said plant, soil, or seed a composition comprising: (a) an inoculant comprising Streptomyces lydicus, and (b) a chemical component comprising a 3,5-disubstituted-1,2,4-oxadiazole or a salt thereof.

2. The method of claim 1, wherein:
a. said composition is capable of reducing said effect of said parasitic nematode population on said plant or seed in soil, relative to a plant or seed in soil wherein said composition was not applied,
b. said composition reduces said parasitic nematode population on said plant or seed in soil, relative to a plant or seed in soil wherein said composition was not applied,
c. said composition reduces the susceptibility to nematode infections or enhances the germination frequency for said seed, relative to a plant or seed in soil wherein said composition was not applied,
d. said effect of said plant parasitic nematode population is reduced by at least 5% for said plant, soil, or seed,
e. one or more characteristics selected from the group consisting of germination frequency, plant height, plant weight, days to maturity, and yield, is enhanced by at least 1% for said plant or seed in soil, or
f. said seed is provided in a container of seeds.

3. The method of claim 1, wherein:
a. said inoculant comprises Streptomyces lydicus strain WYEC 108,
b. said inoculant comprises Streptomyces lydicus strain WYEC 108, and said strain WYEC 108 comprises a strain deposited with the ATCC designated as ATCC 55445,
c. said inoculant comprises Streptomyces lydicus strain WYEC 108, and said strain WYEC 108 comprises spores,
d. said inoculant comprises Streplomyces lydicus strain WYEC 108, iron, and humate, wherein said humate is fulvic or humic acid,
e. said inoculant further comprises a delivery medium comprising an effective amount of a component selected from the group consisting of alginate gel, peat moss, sand, cornmeal, a nitrogen source, and combinations thereof, or
f. said inoculant further comprises a delivery medium comprising an effective amount of a component selected from the group consisting of alginate gel, peat moss, sand, cornmeal, and a nitrogen source, wherein said nitrogen source is ammonium chloride.

4. The method of claim 1, wherein said chemical component comprises a compound of Formula IV or a salt thereof 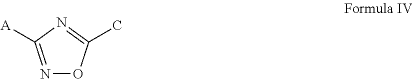
wherein
A is phenyl, pyrazyl, oxazolyl or isoxazolyl, each of which can be independently substituted with one or more substituents selected from the group consisting of halogen, CF₃, CH₃, OCF₃, OCH₃, CN, and C(H)O; and C is thienyl, furanyl, oxazolyl or isoxazolyl, each of which can be independently substituted with one or more substituents selected from F, Cl, CH₃, and OCF₃.

5. The method of claim 4, wherein said chemical component comprises:
a. a compound of Formula IVa or a salt thereof 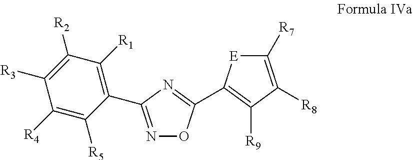
wherein
R₁ and R₅ are independently selected from hydrogen, CH₃, F, Cl, Br, CF₃ and OCF₃;
R₂ and R₄ are independently selected from hydrogen, F, Cl, Br, and CF₃;
R₃ is selected from hydrogen, CH₃, CF₃, F, Cl, Br, OCF₃, OCH₃, CN, and C(H)O;
R₇ and R₈ are independently selected from hydrogen and F;
R₉ is selected from hydrogen, F, Cl, CH₃, and OCF₃; and
E is O, N or S, or
b. a compound of Formula IVb or a salt thereof 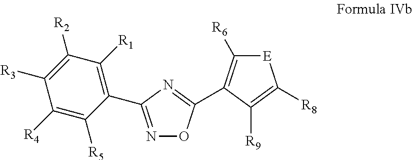
wherein
R₁ and R₅ are independently selected from hydrogen, CH₃, F, Cl, Br, CF₃ and OCF₃;
R₂ and R₄ are independently selected from hydrogen, F, Cl, Br, and CF₃;
R₃ is selected from hydrogen, CH₃, CF₃, F, Cl, Br, OCF₃, OCH₃, CN, and C(H)O;
R₈ is selected from hydrogen and fluorine;
R₆ and R₉ are independently selected from hydrogen, F, Cl, CH₃, and OCF₃; and
E is O or S.

6. The method of claim 1, wherein said chemical component comprises a compound of Formula V or a salt thereof 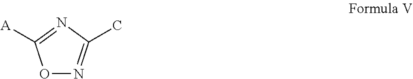
wherein,
A is phenyl, pyrazyl, oxazolyl or isoxazolyl each of which can be independently substituted with one or more substituents selected from halogen, CF₃, CH₃, OCF₃, OCH₃, CN, and C(H)O; and C is thienyl, furanyl, oxazolyl or isoxazolyl each of which can be independently substituted with one or more substituents selected from fluorine, chlorine, CH₃, and OCF₃.

7. The method of claim 6, wherein said chemical component comprises
a. a compound of Formula Va or a salt thereof, 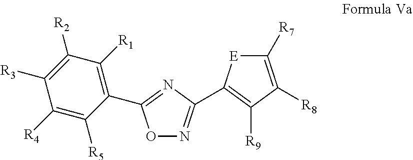
wherein,
R₁ and R₅ are independently selected from hydrogen, CH₃, F, Cl, Br, CF₃ and OCF₃;
R₂ and R₄ are independently selected from hydrogen, F, Cl, Br, and CF₃;
R₃ is selected from hydrogen, CH₃, CF₃, F, Cl, Br, OCF₃, OCH₃, CN, and C(H)O;
R₇ and R are independently selected from hydrogen and fluorine;
R₉ is selected from hydrogen, F, Cl, CH₃, and OCF₃; and
E is O or S, or
b. a compound of Formula Vb or a salt thereof, 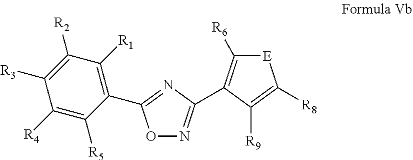
wherein,
R₁ and R₅ are independently selected from hydrogen, CH₃, F, Cl, Br, CF₃ and OCF₃;
R₂ and R₄ are independently selected from hydrogen, F, Cl, Br, and CF₃;
R₃ is selected from hydrogen, CH₃, CF₃, F, Cl, Br, OCF₃, OCH₃, CN, and C(H)O;
R₈ is selected from hydrogen and fluorine;
R₆ and R₉ are independently selected from hydrogen, F, Cl, CH₃, and OCF₃; and
E is O or S.

8. The method of claim 1, wherein said chemical component comprises an effective amount of a compound selected from the group consisting of
3-phenyl-5-(thiophen-2-yl)-1,2,4-oxadiazole,
5-(furan-2-yl)-3-phenyl-1,2,4-oxadiazole,
3-(4-fluorophenyl)-5-(thiophen-2-yl)-1,2,4-oxadiazole,
3-(4-fluorophenyl)-5-(furan-2-yl)-1,2,4-oxadiazole,
3-(4-chlorophenyl)-5-(thiophen-2-yl)-1,2,4-oxadiazole,
3-(4-chlorophenyl)-5-(furan-2-yl)-1,2,4-oxadiazole,
3-(4-bromophenyl)-5-(thiophen-2-yl)-1,2,4-oxadiazole,
3-(4-bromophenyl)-5-(furan-2-yl)-1,2,4-oxadiazole,
3-(4-chloro-2-methylphenyl)-5-(furan-2-yl)-1,2,4-oxadiazole,
3-(2,4-dichlorophenyl)-5-(furan-2-yl)-1,2,4-oxadiazole,
5-(4-chloro-2-methylphenyl)-3-(furan-2-yl)-1,2,4-oxadiazole,
3-(4-chlorophenyl)-5-(thiophen-3-yl)-1,2,4-oxadiazole,
3-(4-chlorophenyl)-5-(furan-3-yl)-1,2,4-oxadiazole,
3-(4-fluorophenyl)-5-(thiophen-3-yl)-1,2,4-oxadiazole,
3-(4-fluorophenyl)-5-(furan-3-yl)-1,2,4-oxadiazole, and
2-(4-chlorophenyl)-5-(thiophen-2-yl)-1,3,4-oxadiazole.

9. The method of claim 8, wherein:
a. said composition further comprises an agronomically acceptable carrier,
b. said composition further comprises a surfactant,
c. said composition further comprises an insecticide, a second nematicide, a fungicide, a herbicide, a pesticide, or a combination thereof,
d. said composition further comprises an insecticide, a second nematicide, a fungicide, a herbicide, a pesticide, or a combination thereof, and said fungicide is selected from the group consisting of aromatic hydrocarbons, benzimidazoles, benzthiadiazoles, carboxamides, carboxylic acid amides, morpholines, phenylamides, phosphonates, quinone outside inhibitors, thiazolidines, thiophanates, thiophene carboxamides, and triazoles,
e. said composition further comprises an insecticide, a second nematicide, a fungicide, a herbicide, a pesticide, or a combination thereof, and said fungicide is selected from the group consisting of aromatic hydrocarbons, benzimidazoles, benzthiadiazoles, carboxamides, carboxylic acid amides, morpholines, phenylamides, phosphonates, quinone outside inhibitors, thiazolidines, thiophanates, thiophene carboxamides, and triazoles, wherein said quinone outside inhibitors are strobilurins,
f. said composition further comprises an insecticide, a second nematicide, a fungicide, a herbicide, a pesticide, or a combination thereof, and said insecticide and said second nematicide are selected from the group consisting of carbamates, diamides, macrocyclic lactones, neonicotinoids, organophosphates, phenylpyrazoles, pyrethrins, spinosyns, synthetic pyrethroids, tetronic and tetramic acids,
g. said composition further comprises an insecticide, a second nematicide, a fungicide, a herbicide, a pesticide, or a combination thereof, and said herbicide is selected from the group consisting of aryloxyphenoxypriopionates, cyclohexandiones, 5-enolpyruvylshikimate-3-phosphate synthase (EPSPS) inhibitors, glutamine synthetase inhibitors, synthetic auxins, photosystem II inhibitors, acetolactate synthase (ALS) or acetohydroxy acid synthase (AHAS) inhibitors, photosystem I inhibitors, protoporphyrinogen oxidase (PPO) inhibitors, mitosis inhibitors, cellulose inhibitors, oxidative phosphorylation uncouplers, fatty acid and lipid biosynthesis inhibitors, auxin transport inhibitors, carotenoid biosynthesis inhibitors, cell division inhibitors, and 4-hydroxyphenylpyruvate dioxygenase inhibitors, or
h. said method further comprises applying one or more compositions selected from the group consisting of one or more agronomically beneficial elements to said first soil, one or more agronomically beneficial elements to said first seed, one or more agronomically beneficial elements to said first plant that germinates from said first seed, one or more lipo-chitooligosaccharides, one or more chitooligosaccharides, one or more chitinous compounds, one or more isoflavonoids, jasmonic acid or derivatives thereof, linolenic acid or derivatives thereof, linoleic acid or derivatives thereof, one or more karrakins, one or more fertilizers, and any combination of the above compositions.

10. The method of claim 1, wherein:
a. said plant is selected from the group consisting of corn, soybean, cotton, wheat, canola, cucurbits vegetables, fruiting vegetables, leafy vegetables, tobacco plants, banana plants, and turf grasses, or
b. said plant parasitic nematode is selected from the group consisting of microorganisms from the genera Pratylenchus, Heterodera, Globodera, Meloidogyne, Rotylenchulus, Hoplolaimus, Belonolaimus, Longidorus, Paratrichodorus, Ditylenchus, Xiphinema, Helicotylenchus, Radopholus, Hirschmanniella, Tylenchorhynchus, Trichodorus, and any combinations thereof.

11. The method of claim 1, wherein:
a. said chemical component is present in a concentration from about 10⁻² to 10⁻¹⁰ Molar,
b. said composition is present in an amount from 10⁻⁹ to 1 micro ram/seed,
c. said composition is present in an amount from 1 gam/container to 1 kilogram/container,
d. said composition is provided in an amount from 8 to 16 ounce/acre,
e. said inoculant is applied at arate of at least 1×10² colony forming units per seed, or
f. said inoculant is applied at a rate of at least 1×10⁷ spores per acre.

12. The method of claim 1, wherein:
a. said applying said composition is selected from the group consisting of coating or applying to said seed with said composition prior to planting, applying to said seed with said composition at planting, applying said composition to said soil prior to planting, applying said composition to said soil at planting, applying said composition to said soil after planting, applying said composition to said soil prior to development stage VI, and applying said composition to the foliage of said plant,
b. said applying said composition further comprises pellet application, drench application, drip application, in-furrow application to said soil, and any combinations thereof, or
c. said composition is in a form selected from the group consisting of a wettable powder, a granular powder, a liquid, a peat-based composition, and a seed coating.

13. The method of claim 12, further comprising:
a. providing a person with said seed and said composition,
b. providing a person with said composition,
c. growing said plant from said seed in said soil with said composition,
d. treating said seed with said composition and providing said treated seed to a farmer for growing in a field,
e. planting said seed in the soil, or
f. immersing said seed in said composition and planting said seed in a field.

14. The method of claim 1, wherein:
a. said reduction of said effect of said parasitic nematode population on said plant or seed in soil by said composition is greater than a reduction of an effect of a parasitic nematode population by said inoculant alone at the same colony forming unit as used in said composition on a plant or seed in soil, or
b. said reduction of said effect of said parasitic nematode population on said plant or seed in soil by said composition is greater than a reduction of an effect of a parasitic nematode population by said chemical component alone at the same concentration as used in said composition on a plant or seed in soil.

15. A plant parasitic nematicidal composition comprising: (a) an inoculant comprising Streptomyces lydicus, and (b) a chemical component comprising a 3,5-disubstituted-1,2,4-oxadiazole or a salt thereof, wherein said composition reduces an effect of a first plant parasitic nematode population on a first plant or seed in soil relative to a second plant or seed in soil in need of reducing said effect of a second plant parasitic nematode population wherein said composition was not applied.

16. The composition of claim 15, wherein:
a. said reduction of said effect of said first plant parasitic nematode population on said first plant or seed in soil by said composition is greater than a reduction of said effect of a third plant parasitic nematode population by said inoculant alone at the same colony forming unit as used in said composition on a third plant or seed in soil, or
b. said reduction of said effect of said first plant parasitic nematode population on said first plant or seed in soil by said composition is greater than a reduction of said effect of a fourth plant parasitic nematode population by said chemical component alone at the same concentration as used in said composition on a fourth plant or seed in soil.

17. The composition of claim 16, wherein:
a. said first plant parasitic nematode population is reduced by at least 5% for said first plant, soil, or seed relative to said second plant parasitic nematode population, or
b. one or more characteristics selected from the group consisting of germination frequency, plant height, plant weight, days to maturity, and yield is enhanced by at least 1% for said first plant, soil, or seed relative to said second plant, soil, or seed.

18. The composition of claim 15, wherein:
a. said inoculant comprises Streptomyces lydicus strain WYEC 108,
b. said inoculant comprises Streptomyces lydicus strain WYEC 108, and said strain WYEC 108 comprises a strain deposited with the ATCC designated as ATCC 55445,
c. said inoculant comprises Streptomyces lydicus strain WYEC 108, and said strain WYEC 108 comprises spores,
d. said inoculant comprises Streptomyces lydicus strain WYEC 108, iron, and humate, wherein said humate is fulvic or humic acid,
e. said inoculant further comprises a delivery medium comprising an effective amount of a component selected from the group consisting of alginate gel, peat moss, sand, cornmeal, and a nitrogen source, or
f. said inoculant further comprises a delivery medium comprising an effective amount of a component selected from the group consisting of alginate gel, peat moss, sand, cornmeal, and a nitrogen source, wherein said nitrogen source is ammonium chloride.

19. The composition of claim 15, wherein said chemical component comprises an effective amount of a compound selected from the group consisting of:
3-phenyl-5-(thiophen-2-yl)-1,2,4-oxadiazole,
5-(furan-2-yl)-3-phenyl-1,2,4-oxadiazole,
3-(4-fluorophenyl)-5-(thiophen-2-yl)-1,2,4-oxadiazole,
3-(4-fluorophenyl)-5-(furan-2-yl)-1,2,4-oxadiazole,
3-(4-chlorophenyl)-5-(thiophen-2-yl)-1,2,4-oxadiazole,
3-(4-chlorophenyl)-5-(furan-2-yl)-1,2,4-oxadiazole,
3-(4-bromophenyl)-5-(thiophen-2-yl)-1,2,4-oxadiazole,
3-(4-bromophenyl)-5-(furan-2-yl)-1,2,4-oxadiazole,
3-(4-chloro-2-methylphenyl)-5-(furan-2-yl)-1,2,4-oxadiazole,
3-(2,4-dichlorophenyl)-5-(furan-2-yl)-1,2,4-oxadiazole,
5-(4-chloro-2-methylphenyl)-3-(furan-2-yl)-1,2,4-oxadiazole,
3-(4-chlorophenyl)-5-(thiophen-3-yl)-1,2,4-oxadiazole,
3-(4-chlorophenyl)-5-(furan-3-yl)-1,2,4-oxadiazole,
3-(4-fluorophenyl)-5-(thiophen-3-yl)-1,2,4-oxadiazole,
3-(4-fluorophenyl)-5-(furan-3-yl)-1,2,4-oxadiazole, and
2-(4-chlorophenyl)-5-(thiophen-2-yl)-1,3,4-oxadiazole.

20. The composition of claim 15, wherein:
a. said first or second plant parasitic nematode population is from the genus Meloidogyne,
b. said first or second plant parasitic nematode population is Meloidogyne incognila,
c. said first or second plant parasitic nematode population is from the genus Heterodera,
d. said first or second plant parasitic nematode population is Heterodera glycines, or
e. said first or second plant parasitic nematode population is any combination of the genus Meloidogyne, the genus Heterodera, Meloidogyne incognita, and Heterodera glycines.
